(19) United States
(12) Patent Application Publication
(10) Pub. No.: US 2019/0370601 A1
(43) Pub. Date: Dec. 5, 2019

(54) MACHINE LEARNING MODEL THAT QUANTIFIES THE RELATIONSHIP OF SPECIFIC TERMS TO THE OUTCOME OF AN EVENT

(71) Applicant: Nutanix, Inc., San Jose, CA (US)

(72) Inventors: Revathi ANIL KUMAR, Santa Clara, CA (US); Mark Albert CHAMNESS, Menlo Park, CA (US)

(73) Assignee: Nutanix, Inc., San Jose, CA (US)

(21) Appl. No.: 15/948,929

(22) Filed: Apr. 9, 2018

(51) Int. Cl. G06K 9/62; G06F 17/30; G06F 15/18

(52) U.S. Cl. CPC G06K 9/629; G06F 17/30616; G06F 17/30539; G06F 2216/03; G06F 17/30666; G06F 17/30315; G06F 15/18

(57) ABSTRACT

A machine learning model is trained to quantify the relationship of specific terms or groups of terms to the outcome of an event. To train the model, a set of data including structured and unstructured data and information describing previous outcomes of the event is received. The unstructured data is analyzed and features corresponding to one or more terms are identified, extracted, and merged together with features extracted from the structured data. The model is trained based at least in part on a set of the merged features, each of which is associated with a value quantifying a relationship of the feature to the outcome of the event. An output is generated based at least in part on a likelihood of the outcome of the event that is predicted using the model and input values corresponding to at least some of the set of features used to train the model.

### FIELD

This disclosure concerns a machine learning model that quantifies the relationship of specific terms or groups of terms to the outcome of an event.

### BACKGROUND

Data mining involves predicting events and trends by sorting through large amounts of data and identifying patterns and relationships within the data. Machine learning uses data mining techniques and various algorithms to construct models used to make predictions about future outcomes of events based on “features” (i.e., attributes or properties that characterize each instance of data used to train a model). Traditionally, data mining techniques have focused on mining structured data (i.e., data that is organized in a predefined manner, such as a record in a relational database or some other type of data structure) rather than unstructured data (e.g., data that is not organized in a pre-defined manner). The reason for this is that structured data more easily lends itself to data mining since its high degree of organization makes it more straightforward to process than unstructured data.

However, unstructured data potentially may be just as or even more useful than structured data for predicting the outcomes of events. While data mining techniques may be applied to unstructured data that has been manually transformed into structured data, manual transformation of unstructured data into structured data is resource-intensive and error prone and is infeasible when large amounts of unstructured data must be transformed and new unstructured data is constantly being created. Moreover, predictions made based on unstructured data may be time-sensitive in their applications and lag time due to the manual transformation of unstructured data into structured data may render any predictions irrelevant by the time they are generated. Most importantly, even if a small amount of unstructured data must be transformed into structured data, traditional data mining approaches may be incapable of evaluating data sets that include both structured and unstructured data.

Thus, there is a need for an improved approach for the data mining of data sets that include both unstructured and structured data.

### SUMMARY

Embodiments of the present invention provide a method, a computer program product, and a computer system for training a machine learning model to quantify the relationship of specific terms to the outcome of an event.

According to some embodiments, a machine learning model is trained to quantify the relationship of specific terms or groups of terms to the outcome of an event. To train the machine learning model, a set of data including structured data, unstructured data, and information describing previous outcomes of the event is received and analyzed. Based at least in part on the analysis, features included among the unstructured data, at least some of which correspond to one or more terms within the unstructured data, are identified, extracted, and merged together with features extracted from the structured data. The machine learning model is then trained to predict a likelihood of the outcome of the event based at least in part on a set of the merged features, each of which is associated with a value that quantifies a relationship of the feature to the outcome of the event. An output is generated based at least in part on a likelihood of the outcome of the event that is predicted using the machine learning model and a set of input values corresponding to at least some of the set of features used to train the machine learning model.

In some embodiments, the unstructured data may include free-form text data that has been merged together from multiple free-form text fields. In various embodiments, the terms corresponding to each of the features may be synonyms. In some embodiments, the features extracted from the unstructured and structured data are merged by associating each column of one or more tables with the features and by populating fields of the table(s) with information describing an occurrence of a term corresponding to each feature associated with the column for each record included among the set of data. Furthermore, in various embodiments, the output may include one or more graphs that plot the likelihood of the outcome of the event over a period of time and/or one or more graphs that plot the value that quantifies the relationship of each feature to previous outcomes of the event over a period of time. In some embodiments, the previous outcomes of the event are previous successful sales attempts and previous failed sales attempts.

Further details of aspects, objects and advantages of the invention are described below in the detailed description, drawings and claims. Both the foregoing general description and the following detailed description are exemplary and explanatory, and are not intended to be limiting as to the scope of the invention.

### BRIEF DESCRIPTION OF THE DRAWINGS

The drawings illustrate the design and utility of embodiments of the present invention, in which similar elements are referred to by common reference numerals. In order to better appreciate the advantages and objects of embodiments of the invention, reference should be made to the accompanying drawings. However, the drawings depict only certain embodiments of the invention, and should not be taken as limiting the scope of the invention.

FIG. 1 illustrates an example system for predicting a likelihood of an outcome of an event using a machine learning model that is trained based at least in part on structured data and unstructured data according to some embodiments of the invention.

FIG. 2 illustrates a flowchart for predicting a likelihood of an outcome of an event using a machine learning model that is trained based at least in part on structured data and unstructured data according to some embodiments of the invention.

FIGS. 3A-3K illustrate an example of predicting a likelihood of an outcome of an event using a machine learning model that is trained based at least in part on structured data and unstructured data according to some embodiments of the invention.

FIG. 4 illustrates a flowchart for analyzing unstructured (and structured) data to identify features and merging features extracted from structured and unstructured data according to some embodiments of the invention.

FIGS. 5A-5D illustrate an example of analyzing unstructured (and structured) data to identify features and merging features extracted from structured and unstructured data according to some embodiments of the invention.

FIG. 6 illustrates a flowchart for predicting a likelihood of a sale using a machine learning model that is trained based at least in part on structured data and unstructured data according to some embodiments of the invention.

FIGS. 7A-7K illustrate an example of predicting a likelihood of a sale using a machine learning model that is trained based at least in part on structured data and unstructured data according to some embodiments of the invention.

FIG. 8 is a block diagram of a computing system suitable for implementing an embodiment of the present invention.

### DETAILED DESCRIPTION OF THE EMBODIMENTS OF THE INVENTION

The present disclosure provides a method, a computer program product, and a computer system for training a machine learning model to quantify the relationship of specific terms or groups of terms to the outcome of an event.

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments,” in various places throughout this specification are not necessarily referring to the same embodiment or embodiments.

As noted above, unstructured data is data that is not organized in any pre-defined manner. For example, consider a text field that allows free-form text data to be entered. In this example, a user may enter several lines of text into the text field that may include numbers, symbols, indentations, line breaks, etc., without any restrictions as to form. This type of text field is commonly used by various industries (e.g., research, sales, etc.) to chronicle events observed on a daily basis. Therefore, data entered into this type of text field may amount to a vast amount of data as it is accumulated over time. As also noted above, since it is not organized in any pre-defined manner, unstructured data poses several problems to the use of data mining techniques by machine learning models to predict trends and the outcomes of events.

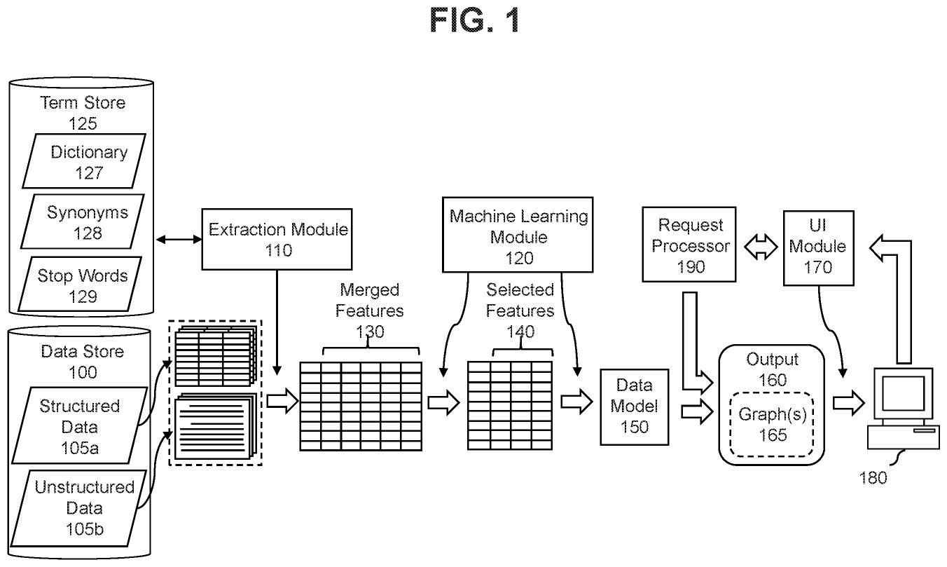

To illustrate a solution to this problem, consider the approach shown in FIG. 1 for predicting a likelihood of an outcome of an event using a machine learning model that is trained based at least in part on structured data and unstructured data according to some embodiments of the invention. The data store 100 contains both structured data 105a (e.g., data stored in relational database tables) and unstructured data 105b (e.g., free-form text data). In some embodiments, the structured data 105a and/or unstructured data 105b may include multiple entries (e.g., multiple free-form text fields) that have been merged together and which may be processed together by the extraction module 110 and the machine learning module 120, which are described below. In other embodiments, the structured data 105a and/or the unstructured data 105b may include multiple separate entries that have not been merged together and which may be processed separately by the extraction module 110 and the machine learning module 120. At least some of the information stored in the structured data 105a and/or the unstructured data 105b also may describe previous outcomes of an event, the likelihood of which is to be predicted by the data model 150, which is described below. For example, the structured data 105a and/or unstructured data 105b may describe previous weather patterns, medical diagnoses, sales of products or services, etc.

The term store 125 may store information associated with various terms (e.g., names, words, model numbers, etc.) that may be included among the structured data 105a and/or the unstructured data 105b. The term store 125 may include a dictionary 127 of terms included among the structured data 105a and/or the unstructured data 105b, synonyms 128 (e.g., alternative words or phrases, abbreviations, etc.) for various terms included in the dictionary 127, as well as stop words 129 that may be included among the structured data 105a and/or the unstructured data 105b. In some embodiments, the dictionary 127, the synonyms 128, and/or the stop words 129 may be stored in one or more relational database tables, in one or more lists, or in any other suitable format. The contents of the term store 125 may be accessed by the extraction module 110, as described below.

In some embodiments, the data store 100 and/or the term store 125 may comprise any combination of physical and logical structures as is ordinarily used for database systems, such as Hard Disk Drives (HDDs), Solid State Drives (SSDs), logical partitions, and the like. The data store 100 and the term store 125 are each illustrated as a single database that is directly accessible by the extraction module 110. However, in some embodiments, the data store 100 and/or the term store 125 may correspond to a distributed database system having multiple separate databases that contain some portion of the structured data 105a, the unstructured data 105b, the dictionary 127, the synonyms 128, and/or the stop words 129. In such embodiments, the data store 100 and/or the term store 125 may be located in different physical locations and some of the databases may be accessible via a remote server.

The extraction module 110 accesses the data store 100 and analyzes the unstructured data 105b to identify various features included among the unstructured data 105b. To identify the features, the extraction module 110 may preprocess the unstructured data 105b (e.g., via parsing, stemming/lemmatizing, etc.) based at least in part on information stored in the term store 125, as further described below. In some embodiments, at least some of the features identified by the extraction module 110 may correspond to terms (e.g., words or names) that are included among the unstructured data 105b. For example, if the unstructured data 105b includes several sentences of text, the sentences may be parsed into individual terms or groups of terms that are identified by the extraction module 110 as features. In some embodiments, in addition to terms, some of the features identified by the extraction module 110 may correspond to other types of values (e.g., integers, decimals, characters, etc.). In the above example, if the sentences include combinations of numbers and symbols (e.g., “$59.99,” or “Model# M585734”), these combinations of numbers and symbols also may be identified as features. In some embodiments, groups of terms (e.g. “no budget” or “not very happy”) may be identified as features. In some embodiments, terms identified by the extraction module 110 are automatically added to the dictionary 127 by the extraction module 110. Terms identified by the extraction module 110 also may be communicated to a user (e.g., a system administrator) via a user interface (e.g., a graphical user interface or “GUI”) and added to the dictionary 127, the synonyms 128, and/or the stop words 129 upon receiving a request to do so via the user interface.

In some embodiments, the extraction module 110 also may access the data store 100 and analyze the structured data 105a to identify various features included among the structured data 105a. For example, suppose that the structured data 105a includes relational database tables that have rows that each correspond to different entities (e.g., individuals, organizations, etc.) and columns that each correspond to different attributes that may be associated with the entities (e.g., names, geographic locations, number of employees, hiring rates, salaries, etc.). In this example, the extraction module 110 may search each of the relational database tables and identify features corresponding to the attributes or the values of attributes for the entities. In the above example, the extraction module 110 may identify features corresponding to values of a geographic location attribute for the entities that include states or countries in which the entities are located.

In some embodiments, when analyzing the structured data 105a and/or the unstructured data 105b, the extraction module 110 also may identify one or more records included among the structured data 105a and/or the unstructured data 105b, in which each record is relevant to a specific entity. For example, if the structured data 105a and the unstructured data 105b are associated with an organization, each record may correspond to a different group or a different member of the organization. In embodiments in which the unstructured data 105b includes multiple entries (e.g., multiple free-form text fields) that have been merged together, entries that have been merged together may correspond to a common record. In embodiments in which the unstructured data 105b includes multiple separate entries that have not been merged together, each entry may be associated with a record based on a record identifier (e.g., a record name or a record number) associated with each entry. In embodiments in which the structured data 105a includes one or more relational database tables, each row or column within the tables may correspond to a different record.

Once the extraction module 110 has identified various features included among the structured data 105a and/or the unstructured data 105b, the extraction module 110 may extract the features and merge them together (merged features 130). For example, features included among the unstructured data 105b identified by the extraction module 110 may be extracted and populated into columns of a table, such that each feature corresponds to a column of the table and fields within the column are populated by the corresponding values of the feature for various records. In this example, features included among the structured data 105a identified by the extraction module 110 also may be extracted and populated into columns of the same table in an analogous manner. At least one of the merged features 130 may correspond to previous outcomes of the event to be predicted by the data model 150, as further described below.

Once the extraction module 110 has merged features extracted from the structured data 105a and the unstructured data 105b, the machine learning module 120 may train a machine learning model (data model 150) to predict a likelihood of the outcome of the event based at least in part on a subset of the merged features 130. In some embodiments, this subset of features (selected features 140) may be selected from the merged features 130 based at least in part on a value that quantifies their relationship to an outcome of the event to be predicted. For example, suppose that the data model 150 is trained using logistic regression. In this example, the selected features 140 used to train the data model 150 may be selected from the merged features 130 via a regularization process. In various embodiments, when training the data model 150, the machine learning module 120 may identify a set of records that are associated with previous occurrences of the event (e.g., records associated with binary values for a feature corresponding to previous occurrences of the event) and a set of records that are not associated with previous occurrences of the event (e.g., records associated with null values for a feature corresponding to previous occurrences of the event). In such embodiments, the machine learning module 120 may include the set of records associated with previous occurrences of the event in a training dataset and the set of records that are not associated with previous occurrences of the event in a test dataset.

Once trained, the data model 150 may be used to generate an output 160 based at least in part on a likelihood of the outcome of the event that is predicted by the data model 150. The likelihood of the outcome of the event may be predicted by the data model 150 based at least in part on a set of input values corresponding to at least some of the selected features 140 used to train the data model 150. For example, for each record included among the structured data 105a and/or the unstructured data 105b that is not associated with previous outcomes of the event to be predicted by the data model 150, the data model 150 may predict the likelihood of the outcome of the event. In this example, the likelihood for each record may be included in the output 160 generated by the data model 150. In some embodiments, the output 160 generated by the data model 150 also may indicate the relationship of one or more features included among the selected features 140 to the predicted likelihood of the outcome of the event. For example, in embodiments in which the data model 150 is trained using a logistic regression algorithm, an output 160 generated by the data model 150 may include beta values (estimates of the regression coefficients) associated with one or more of the selected features 140. In some embodiments, the output 160 may include one or more graphs 165. For example, a graph 165 included in the output 160 may plot the likelihood of the outcome of the event predicted by the data model 150 over a period of time. As an additional example, a graph 165 included in the output 160 may plot a value that quantifies a relationship of a selected feature 140 used to train the data model 150 to the likelihood of the outcome of the event predicted by the data model 150 over a period of time.

In some embodiments, the output 160 may be presented at a management console 180 via a user interface (UI) generated by the UI module 170. The management console 180 may correspond to any type of computing station that may be used to operate or interface with the request processor 190, which is described below. Examples of such computing stations may include workstations, personal computers, laptop computers, or remote computing terminals. The management console 180 may include a display device, such as a display monitor or a screen, for displaying interface elements and for reporting data to a user. The management console 180 also may comprise one or more input devices for a user to provide operational control over the activities of the applications, such as a mouse, a touch screen, a keypad, or a keyboard. The users of the management console 180 may correspond to any individual, organization, or other entity that uses the management console 180 to access the UI module 170.

In addition to generating a UI that presents the output 160, the UI generated by the UI module 170 also may include various interactive elements that allow a user of the management console 180 to submit a request. For example, as briefly described above, new terms identified by the extraction module 110 also may be communicated to a user via a UI and added to the dictionary 127, the synonyms 128, and/or the stop words 129 upon receiving a request to do so via the UI. As an additional example, a set of input values corresponding to at least some of the selected features 140 used to train the data model 150 may be received via a UI generated by the UI module 170. In embodiments in which the UI generated by the UI module 170 is a GUI, the GUI may include text fields, buttons, check boxes, scrollbars, menus, or any other suitable elements that would allow a request to be received at the management console 180 via the GUI.

Requests received at the management console 180 via a UI may be forwarded to the request processor 190 via the UI module 170. In embodiments in which a set of inputs for the data model 150 are forwarded to the request processor 190, the request processor 190 may communicate the inputs to the data model 150, which may generate the output 160 based at least in part on the inputs. In some embodiments, the request processor 190 may process a request by accessing one or more components of the system described above (e.g., the data store 100, the term store 125, the extraction module 110, the machine learning module 120, the merged features 130, the selected features 140, the data model 150, the output 160, and the UI module 170).

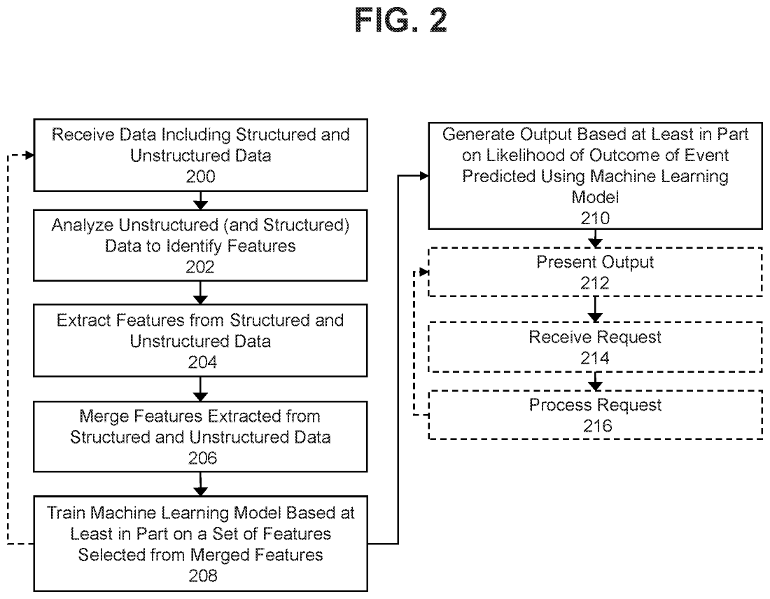

FIG. 2 is a flowchart for predicting a likelihood of an outcome of an event using a machine learning model that is trained based at least in part on structured data and unstructured data according to some embodiments of the invention. Some of the steps illustrated in the flowchart are optional in different embodiments. In some embodiments, the steps may be performed in an order different from that described in FIG. 2.

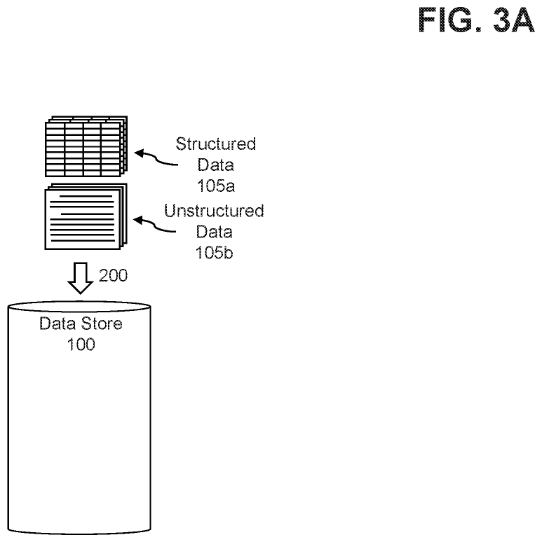

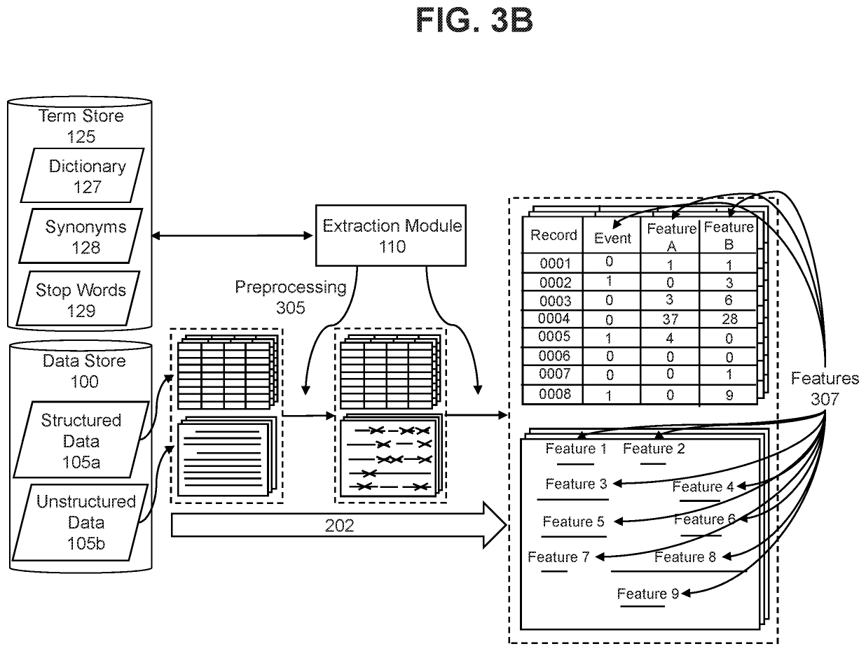

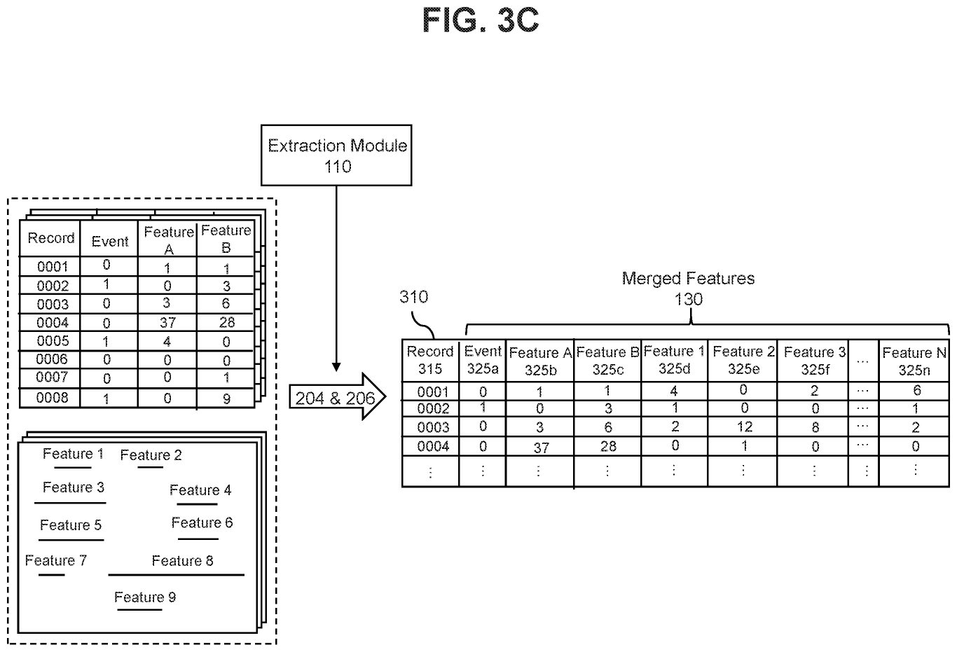

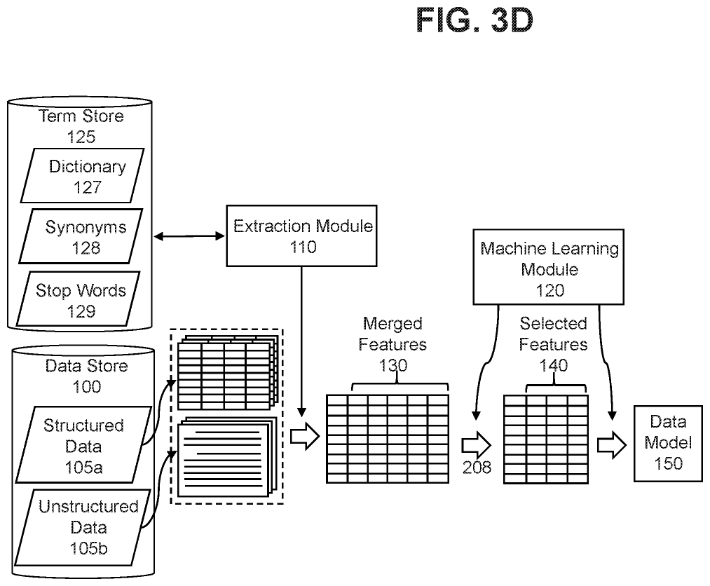

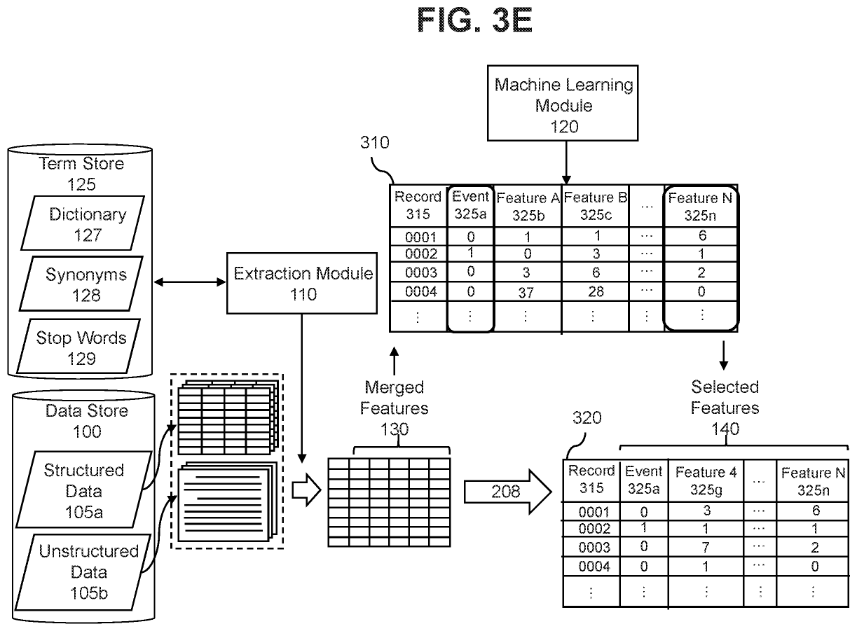

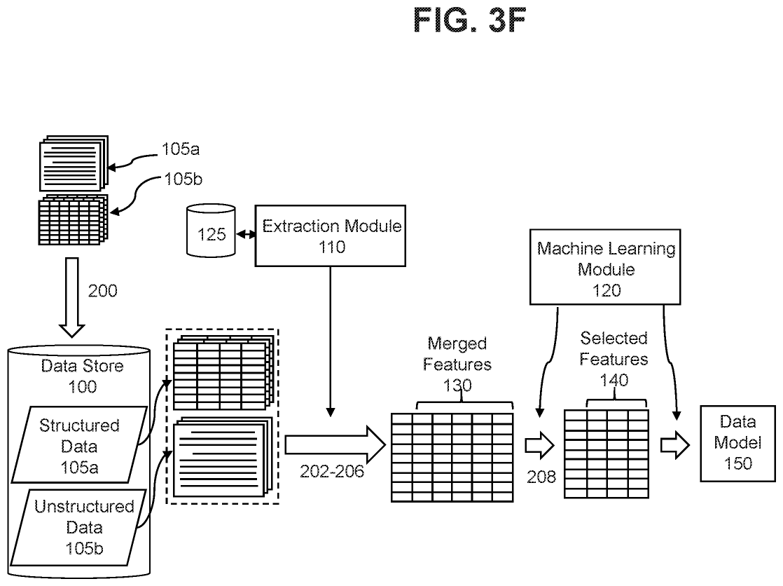

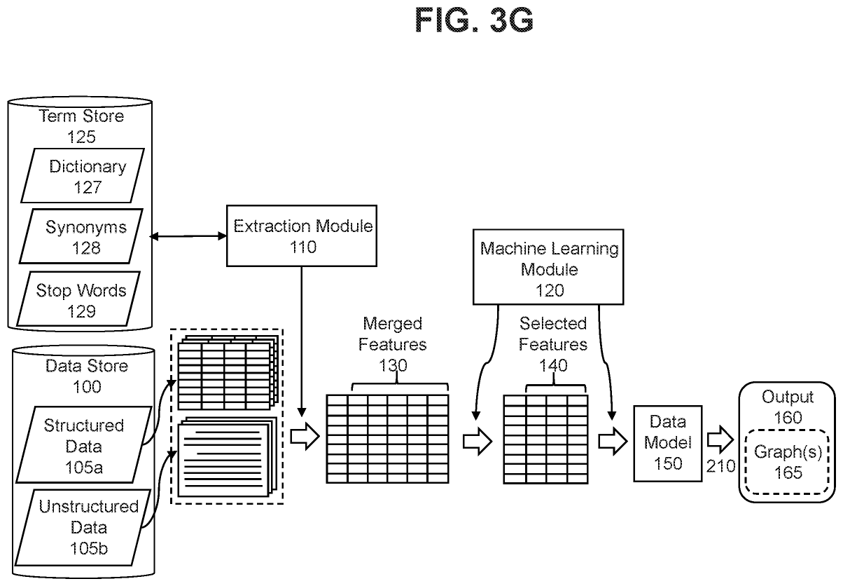

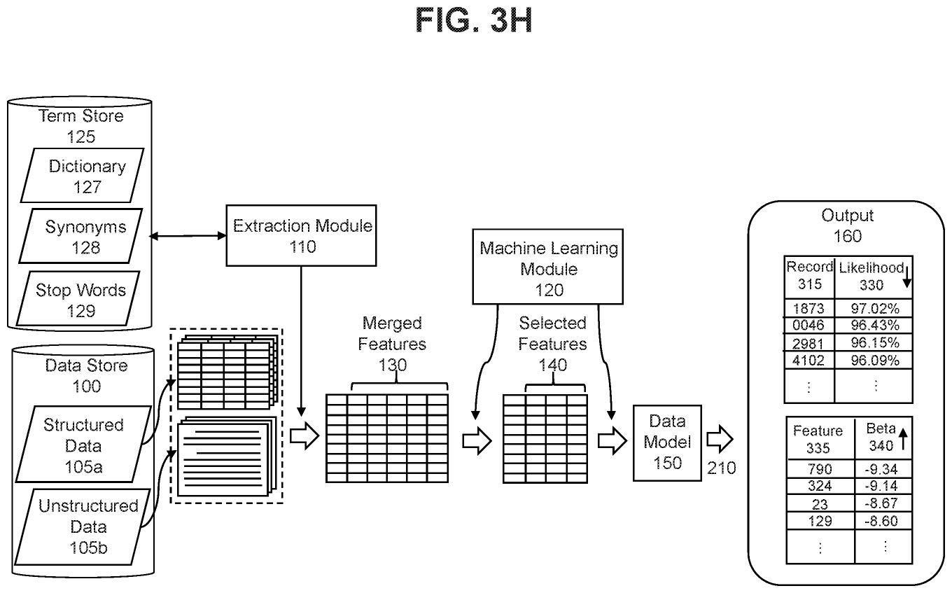

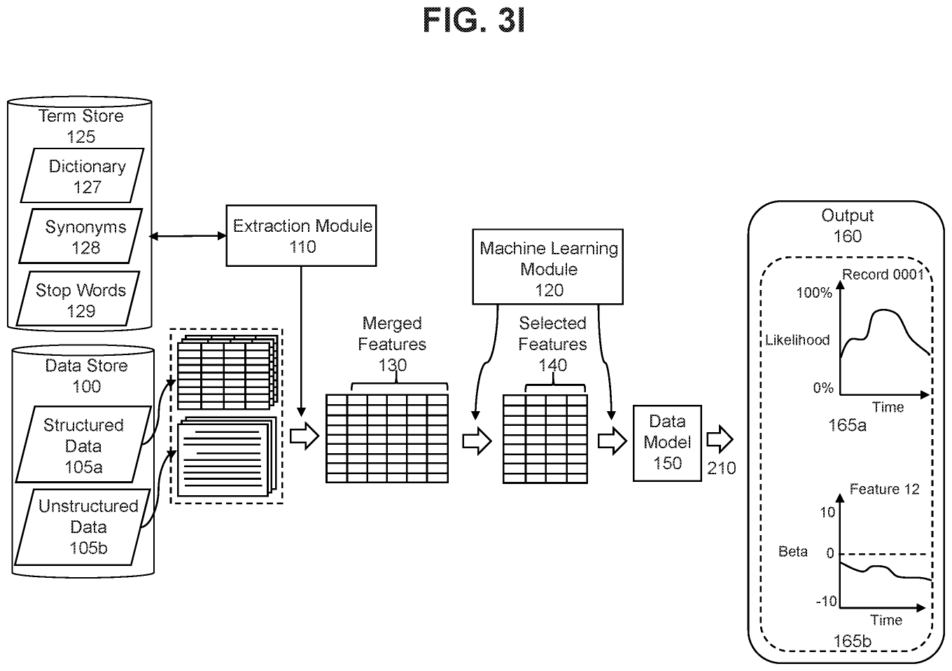

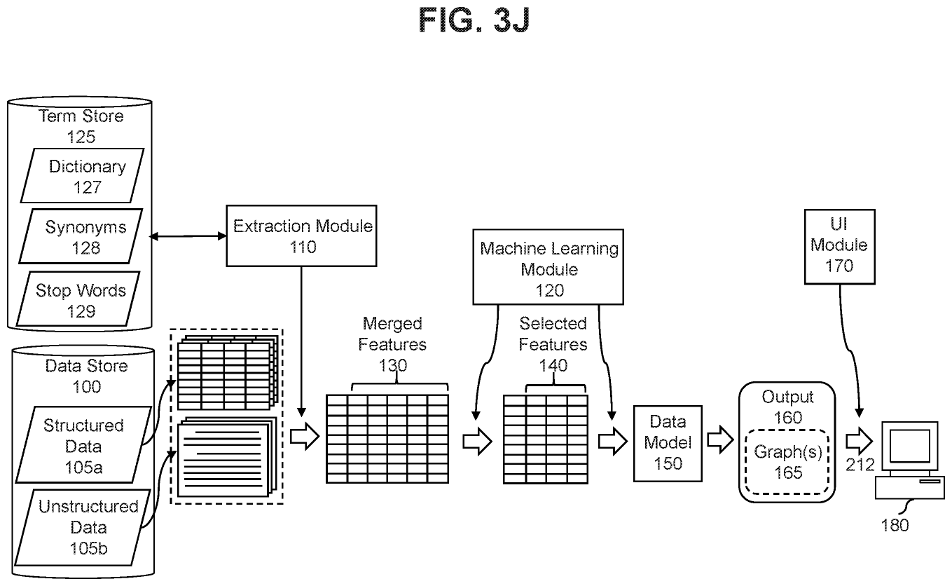

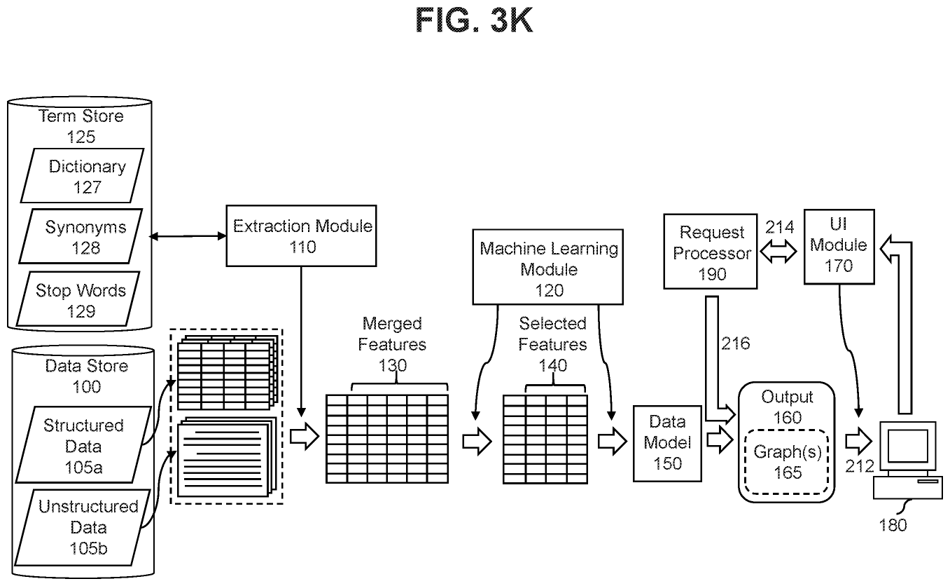

As shown in FIG. 2, the flowchart begins when data including structured data 105a and unstructured data 105b is received (in step 200). For example, as shown in FIG. 3A, a set of structured data 105a (e.g., data stored in relational database tables) and a set of unstructured data 105b (e.g., free-form text data) are received and stored in the data store 100. As described above, in some embodiments, the unstructured data 105b may include multiple entries (e.g., multiple free-form text fields) that have been merged together and which may be processed together by the extraction module 110 and the machine learning module 120, while in other embodiments, the unstructured data 105b may include multiple separate entries that have not been merged together and which may be processed separately. Furthermore, as also described above, at least some of the structured data 105a and/or the unstructured data 105b also may include information describing previous outcomes of an event, the likelihood of which is to be predicted by the data model 150.

Referring back to FIG. 2, the unstructured data 105b is analyzed to identify various features included among the unstructured data 105b (in step 202). As indicated in step 202, in some embodiments, the structured data 105a may be analyzed as well to identify various features included among the structured data 105a. As described above, to identify the features, the extraction module 110 may perform various types of preprocessing procedures on the unstructured data 105b based at least in part on information stored in the term store 125. The preprocessing procedures may involve parsing the data, stemming/lemmatizing certain words, removing stop words, identifying synonyms/misspelled words, transforming the data, etc., and accessing the dictionary 127, the synonyms 128, and/or the stop words 129 stored in the term store 125, as further described below. In some embodiments, at least some of the features may correspond to terms (e.g., words or names) or other types of values (e.g., integers, decimals, characters, etc.). For example, as shown in FIG. 3B, which continues the example of FIG. 3A, once preprocessing 305 is complete, the terms remaining among the unstructured data 105b may be identified by the extraction module 110 as features 307 (Feature 1 through Feature 9). As also shown in this example, columns of the database tables (Event, Feature A, and Feature B) included among the structured data 105a also may be identified by the extraction module 110 as features 307. In some embodiments, analysis of the structured data 105a may be optional. For example, in FIG. 3B, analysis of the structured data 105a may not be required if each column within the tables of the structured data 105a corresponds to a feature by default.

As described above, in some embodiments, the extraction module 110 also may identify one or more records included among the structured data 105a and/or the unstructured data 105b, in which each record is relevant to a specific entity. In such embodiments, once the extraction module 110 has identified one or more records included among the structured data 105a and/or the unstructured data 105b, the extraction module 110 may then determine occurrences of the identified features within each record. For example, the extraction module 110 may determine a count indicating a number of times that a term corresponding to a feature appears within each record included among the structured data 105a and the unstructured data 105b. As an additional example, the extraction module 110 may determine whether a term corresponding to an identified feature appears within a record included among the structured data 105a and the unstructured data 105b.

Referring back to FIG. 2, next, the extraction module 110 may extract the identified features and merge them together (in steps 204 and 206). In some embodiments, the features may be merged by populating them into one or more tables. For example, as shown in FIG. 3C, which continues the example discussed above with respect to FIGS. 3A-3B, features included among the structured data 105a identified by the extraction module 110 may be extracted and populated into columns (Event 325a, Feature A 325b, and Feature B 325c) of a table 310, such that each feature corresponds to a column 325 of the table 310 and fields within the columns 325 are populated by the corresponding values of the features for various records 315 identified by record numbers (0001, 0002, 0003, 0004, etc.). In this example, features included among the unstructured data 105b identified by the extraction module 110 may be extracted and populated into columns (Feature 1 325d, Feature 2 325e, Feature 3 325f, . . . Feature N 325n) of the same table 310 in an analogous manner, creating a single table of merged features 130. In embodiments in which the extraction module 110 determines occurrences of the identified features within each record, the values of the features for various records may correspond to information describing these occurrences. For example, as shown in FIG. 3C, Feature 1 occurred four times within record 0001, once within record 0002, twice within record 0003, etc. As described above, at least one of the merged features 130 (e.g., Event) may correspond to previous outcomes of the event to be predicted by the data model 150.

Referring back to FIG. 2, a machine learning model is trained to predict the likelihood of the outcome of the event based at least in part on a set of features selected from the merged features 130 (in step 208). For example, as shown in FIG. 3D, which continues the example discussed above with respect to FIGS. 3A-3C, the machine learning module 120 may train the data model 150 based at least in part on a set of selected features 140. In this example, the training data used to train the data model 150 may include values corresponding to the selected features 140 for various records, which may be populated into one or more tables. In some embodiments, the set of features included among the selected features 140 is smaller than the set of features included among the merged features 130. In such embodiments, this may significantly reduce the amount of data that must be processed. For example, as shown in FIG. 3E, which continues the example discussed above with respect to FIGS. 3A-3D, the machine learning module 120 only selects some of the merged features 130 (Event 325a, Feature 4 325g, . . . Feature N 325n) and populates values corresponding to the selected features 140 for various records 315 into a table 320. As described above, in various embodiments, when training the data model 150, the machine learning module 120 may identify a set of records that are associated with previous occurrences of the event (e.g., records associated with binary values for a feature corresponding to previous occurrences of the event) and a set of records that are not associated with previous occurrences of the event (e.g., records associated with null values for a feature corresponding to previous occurrences of the event), such that the appropriate records may be included in a training dataset and a test dataset.

The data model 150 may be trained by the machine learning module 120 using a regression algorithm (e.g., logistic regression or step-wise regression), a decision tree algorithm (e.g., random forest), or any other suitable machine learning algorithm. In some embodiments, the machine learning module 120 may train multiple data models 150 and select a data model 150 based at least in part on a process that prevents overfitting of the data model 150 to data used to train the model (e.g. via regularization). For example, referring to FIG. 3E, suppose that there are 50,000 merged features 130, such that table 310 includes 50,000 columns that each correspond to a merged feature 130. In this example, suppose also that logistic regression is used to train the data model 150 and that the machine learning module 120 automatically excludes merged features 130 associated with beta values (estimates of the regression coefficients) smaller than a threshold value from the selected features 140. Continuing with this example, a regularization process (e.g., L1, L2, or L1/L2 regularization) then imposes a penalty on each of the merged features 130 that potentially may be included among the selected features 140 used to train the data model 150 based on whether the feature improves or diminishes the ability of the data model 150 to predict the outcome of the event. In this example, if the most accurate data model 150 identified by the machine learning module 120 has selected 5,000 features from the 50,000 merged features 130, this data model 150 is output by the machine learning module 120.

Referring back to FIG. 2, in some embodiments the steps of the flow chart described above may be repeated each time new structured data 105a and/or new unstructured data 105b is received (in step 200). In such embodiments, steps 200 through 208 may be repeated, allowing the data model 150 to be updated dynamically by being retrained using new or different combinations of the merged features 130. For example, as shown in FIG. 3F, which continues the example discussed above with respect to FIGS. 3A-3E, new structured data 105a and new unstructured data 105b are received and stored among the structured data 105a and the unstructured data 105b, respectively, in the data store 100. Then, as also shown in FIG. 3F, the extraction module 110 identifies, extracts, and merges features from the structured data 105a and the unstructured data 105b (in steps 202-206) and the machine learning module 120 retrains the data model 150 based at least in part on a set of selected features 140 corresponding to a subset of the merged features 130 (in step 208). In some embodiments, efficiency may be improved by processing structured data 105a and/or unstructured data 105b only for records for which new data has been received.

Referring again to FIG. 2, once the data model 150 has been trained, it may generate an output 160 based at least in part on one or more likelihoods of the outcome of the event predicted using the data model 150 (in step 210). The likelihoods of the outcome of the event may be predicted based at least in part on a set of input values to the data model 150, in which the input values correspond to at least some of the selected features 140. For example, as shown in FIG. 3G, which continues the example discussed above with respect to FIGS. 3A-3F, the data model 150 may generate an output 160 that includes one or more predicted likelihoods of the outcome of the event. In this example, the likelihoods included in the output 160 may be predicted by the data model 150 for one or more records included among the structured data 105a and/or the unstructured data 105b that are not associated with previous outcomes of the event (e.g., previous successful attempts or previous failed attempts to achieve the outcome).

A predicted likelihood included in the output 160 may be expressed in various ways. In some embodiments, a predicted likelihood may be expressed numerically. For example, if the output 160 includes an 81 percent predicted likelihood of the outcome of the event for a particular record, the predicted likelihood may be expressed as a percentage (i.e., 81%), as a decimal (i.e., 0.81), as a score (e.g., 81 in a range of scores between 0 and 100), etc. In alternative embodiments, a predicted likelihood may be expressed non-numerically. In the above example, the predicted likelihood may be expressed non-numerically based on comparisons of the predicted likelihood to one or more thresholds (e.g., “highly likely to occur” if the predicted likelihood is greater than 95%, “unlikely to occur” if the predicted likelihood is between 25% and 45%, etc.). Furthermore, in various embodiments, a predicted likelihood included in the output 160 may be associated with a confidence level. In such embodiments, the confidence level may be determined based at least in part on the amount of structured data 105a and/or unstructured data 105b used to train the data model 150.

The output 160 may be generated based on multiple predicted likelihoods. In some embodiments, predicted likelihoods included in the output 160 may be expressed for a group of records. For example, predicted likelihoods may be expressed for a group of records having a common attribute (e.g., a geographic region associated with entities corresponding to the records) or a common value for a particular selected feature 140. Additionally, in various embodiments, the predicted likelihoods included in the output 160 may be sorted. For example, as shown in FIG. 3H, which continues the example discussed above with respect to FIGS. 3A-3G, the output 160 may include a table that lists each record 315 and its corresponding predicted likelihood 330 (expressed as a percentage in this example). In this example, the table sorts the records 315 by decreasing likelihood 330. The output 160 therefore may reduce a large amount of structured data 105a and unstructured data 105b for each record into a single value corresponding to the predicted likelihood of the outcome of the event.

In various embodiments, in addition to the predicted likelihood(s) of the outcome of the event, the output 160 generated by the data model 150 also may include additional types of information. In some embodiments, the output 160 may indicate the relationship of one or more of the selected features 140 to the predicted likelihood of the outcome of the event. Furthermore, in embodiments in which the data model 150 is trained using a regression algorithm, the output 160 generated by the data model 150 may include beta values (estimates of the regression coefficients) associated with one or more of the selected features 140. For example, as shown in FIG. 3H, the output 160 may include a table that lists each feature 335 and its corresponding beta value 340. In this example, the table sorts the features 335 by increasing beta value 340. Although the features 335 included in the table are identified by a numerical identifier, in some embodiments, the identifier may be a term that corresponds to the feature 335 (e.g., a geographic location, a gender, a height, a weight, etc.). Furthermore, as shown in FIG. 3I, which continues the example discussed above with respect to FIGS. 3A-3H, in some embodiments, the output 160 may include one or more graphs 165. The graphs 165 may plot information included in the output 160 that has been tracked over a period of time. As shown in FIG. 3I, the output 160 may include a graph 165a that plots the likelihood of the outcome of the event (expressed as a percentage) predicted for a particular record (Record 0001) over a period of time. As also shown in FIG. 3I, the output 160 also may include a graph 165b that plots a value (beta value, usually called the estimate of the regression coefficient) that quantifies a relationship of a particular selected feature 140 (Feature 12) used to train the data model 150 to the likelihood of the outcome of the event predicted over a period of time.

Referring back to FIG. 2, in some embodiments, once generated, the output 160 of the data model 150 may then be presented (in step 212). In some embodiments, the output 160 may be presented to a user (e.g., a system administrator) at a management console 180. For example, as shown in FIG. 3J, which continues the example discussed above with respect to FIGS. 3A-3I, the output 160 may be presented at a management console 180 via a UI generated by the UI module 170.

Referring once more to FIG. 2, once the output 160 has been presented, a request may be received (in step 214) and processed (in step 216). Furthermore, once the request has been processed, in some embodiments, some of the steps of the flow chart described above may be repeated each time a new request is received (in step 214). In such embodiments, steps 212 through 216 may be repeated. For example, as shown in FIG. 3K, which continues the example discussed above with respect to FIGS. 3A-3J, if a request is received from the management console 180 via a UI generated by the UI module 170, the request may be forwarded to and processed by the request processor 190. The request processor 190 may then generate an output 160 which may then be presented. As described above, the request processor 190 may access any portion of the system (e.g., the data store 100, the data model 150, etc.) to process a request. For example, suppose that a request received at the management console 180 corresponds to a request for information describing the selected features 140 that contributed the most to a difference between the likelihood of the outcome of the event predicted for a particular record at two different times. In this example, based on the record and times identified in the request, the request processor 190 may access the data model 150 and values of the selected features 140 for the identified record, determine a contribution of each of the selected features 140 to the difference for the identified record, and sort the selected features 140 based on their contribution. Continuing with this example, the request processor 190 may generate an output 160 that includes a sorted list of the selected features 140 that is presented at the management console 180 via a GUI generated by the UI module 170.

As described above, in some embodiments, the request processor 190 may receive a set of inputs for the data model 150 and communicate them to the data model 150, which may generate the output 160 based at least in part on the inputs. For example, as shown in FIG. 3K, if a request to run the data model 150 using a particular set of inputs is received at the management console 180 and forwarded to the request processor 190, the inputs may be forwarded to the data model 150, which generates an output 160. This output 160 may then be presented at the management console 180 via a UI generated by the UI module 170.

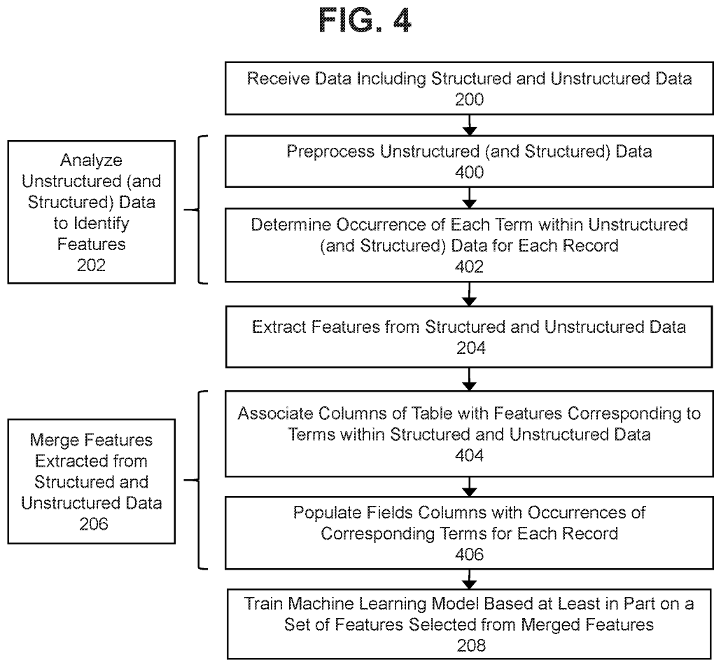

FIG. 4 illustrates a flowchart for analyzing unstructured (and structured) data to identify features and merging features extracted from structured and unstructured data according to some embodiments of the invention. In some embodiments, the steps may be performed in an order different from that described in FIG. 4.

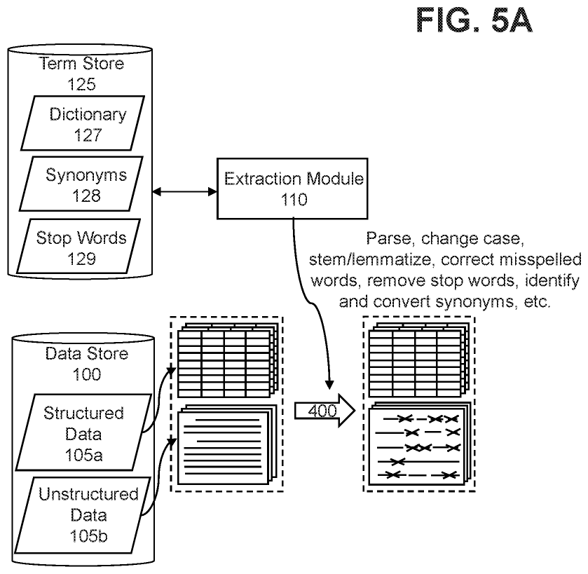

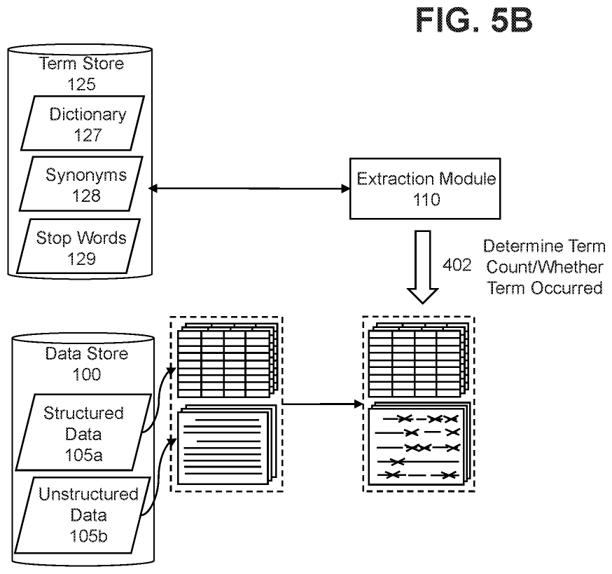

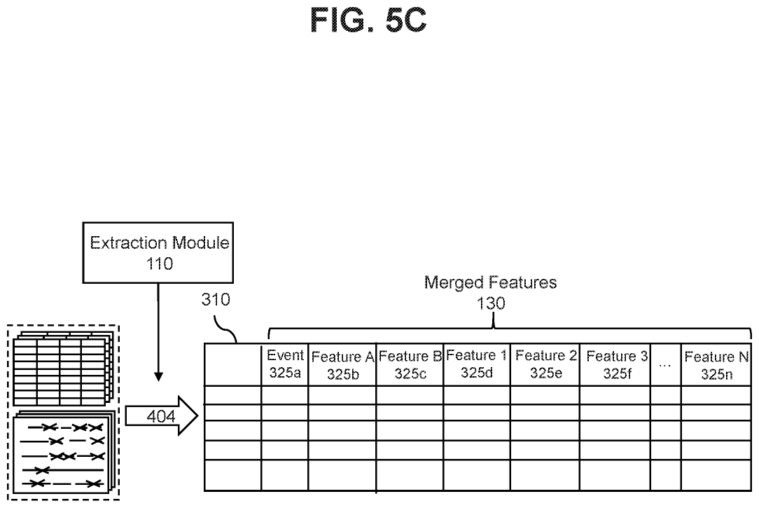

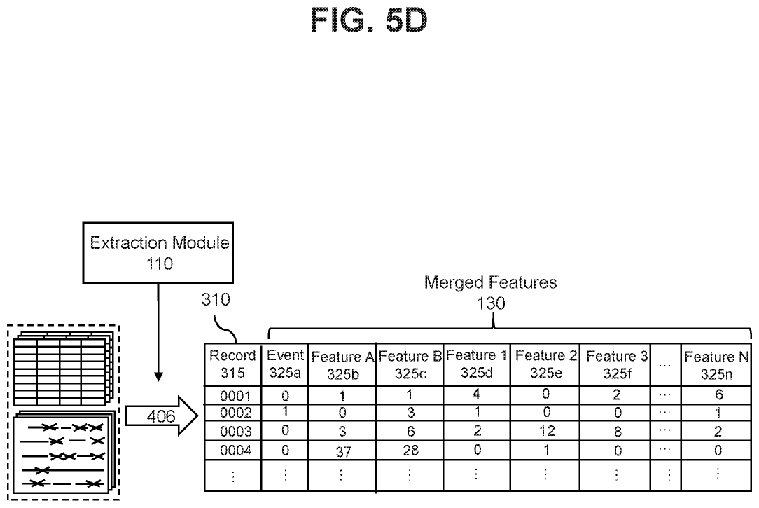

As shown in FIG. 4, the flowchart begins with step 200 in which data including structured data 105a and unstructured data 105b are received, as previously discussed above in conjunction with FIG. 2. Then, the step of analyzing the unstructured data 105b (and in some embodiments, the structured data 105a) to identify features included among this data (in step 202) may involve preprocessing the data (in step 400). As shown in the example of FIG. 5A, preprocessing may involve parsing the data, changing the case of words (e.g., from uppercase to lowercase), stemming or lemmatizing certain words (i.e., reducing words to their stems or lemmas), correcting misspelled words, removing stop words, identifying and converting synonyms, etc. based on information stored in the term store 125. For example, the extraction module 110 may parse sentences included among the unstructured data 105b into individual terms and access the dictionary 127 to identify each term included in the structured data 105a and the unstructured data 105b. In this example, terms identified by the extraction module 110 that are not found in the dictionary 127 may be added to the dictionary 127 by the extraction module 110 or communicated to a user via a UI and added to the dictionary 127, the synonyms 128, and/or the stop words 129 at a later time upon receiving a request to do so via the UI. Continuing with this example, the extraction module 110 may compare terms found in the structured data 105a and the unstructured data 105b to terms included in the dictionary 127, determine whether the terms are spelled correctly based on the comparison, and correct the spelling of any words that the extraction module 110 determines are spelled incorrectly. In the above example, the extraction module 110 also may access a list of stop words 129 stored in the term store 125 to identify words that should be removed (e.g., articles such as “a” and “the”) and remove the stop words 129 that are identified.

Furthermore, as also shown in FIG. 5A, preprocessing also may involve identifying terms that are synonyms for other terms and then converting them into a common term. For example, if the extraction module 110 identifies a term included in the structured data 105a and/or the unstructured data 105b corresponding to a name of an entity, such as “Beta Alpha Delta Corp.,” the extraction module 110 may access a table of synonyms 128 stored in the term store 125 and determine whether the name is included in the table. In this example, the table of synonyms 128 may indicate that the entity is known by multiple names, such as “Beta Alpha Delta Corporation” (its full name), “BADC” (its stock symbol), “BAD Corp.,” etc. Once the extraction module 110 has identified terms that are synonyms for other terms, the extraction module 110 may convert one or more of the terms into a common term specified in the synonyms 128. In the above example, if the table of synonyms 128 indicates that the common term to which the entity should be referred is its full name, the extraction module 110 may convert the name accordingly, such that the entity is only referenced by a single consistent term throughout the structured data 105a and the unstructured data 105b. As described above in conjunction with FIG. 2, in some embodiments, analysis of the structured data 105a to identify features included among the structured data 105a may be optional. In such embodiments, preprocessing of the structured data 105a may be optional as well.

Referring again to FIG. 4, once the data has been preprocessed, the occurrence of each term within the data is determined for each record (in step 402). As shown in FIG. 5B, which continues the example discussed above with respect to FIG. 5A in some embodiments, the occurrence of each term within the data is determined for each record by the extraction module 110. In some embodiments, the occurrence of each term corresponds to a count of occurrences of each term within a corresponding record. For example, each time a particular term is found within a record, the extraction module 110 may increment a count associated with the term and the record. In other embodiments, the occurrence of each term may correspond to whether or not the term occurred within a corresponding record. Alternatively, in the above example, the extraction module 110 may determine a binary value associated with the term and the record based on whether the term is found within the record (e.g., a value of 1 if the term is found within the record and a value of 0 if the term is not found within the record). In the above examples, the count/binary value associated with the term may be stored by the extraction module 110 in association with information identifying the record (e.g., among the structured data 105a in the data store 100). Similar to step 400, in embodiments in which analysis of the structured data 105a to identify features included among the structured data 105a may be optional, determining the occurrence of each term within the structured data 105a for each record may be optional as well.

Referring back to FIG. 4, once the occurrence of each term has been determined, the extraction module 110 may extract the identified features (in step 204) and merge them together (in step 206). As described above, in some embodiments, the extracted features may be merged by populating them into one or more tables. In such embodiments, this may involve associating columns of a table with features corresponding to terms or groups of terms found within the structured data 105a and the unstructured data 105b (in step 404). For example, as shown in FIG. 5C, which continues the example discussed above with respect to FIGS. 5A-5B, the extraction module 110 associates different columns 325 of a table 310, with different features (Event, Feature A, Feature B, Feature 1, etc.) extracted from the structured data 105a and the unstructured data 105b (merged features 130).

Referring again to FIG. 4, merging together the features from the structured data 105a and the unstructured data 105b in step 206 also may involve populating the fields of the columns of the table with information describing the occurrences of the corresponding terms for each record (in step 406). In embodiments in which the occurrence of each term corresponds to a count of occurrences of the term within a corresponding record, a value of a field within a column corresponding to a merged feature 130 may be based on a number of times that a term corresponding to the merged feature 130 appears within a corresponding record and/or a number of times that an outcome of an event previously occurred for a record. For example, as shown in FIG. 5D, which continues the example discussed above with respect to FIGS. 5A-5C, fields of the columns 325 are populated by the extraction module 110 with information describing the occurrences of the corresponding terms for each record 315. In this example, the column corresponding to Feature A 325b may be populated by integer values corresponding to counts of a term corresponding to Feature A 325b appearing within each record 315, such that the values indicate that the term appeared once within record 0001, did not appear within record 0002, appeared three times within record 0003, appeared 37 times within record 0004, etc. Alternatively, in the above example, the values in the columns 325 may be transformed/calculated based at least in part on the counts (e.g., by calculating a natural logarithm of each count). In embodiments in which the occurrence of each term corresponds to whether or not the term occurred within a corresponding record, a value of a field within a column corresponding to a merged feature 130 may describe whether or not the merged feature 130 appears within a corresponding record and/or whether or not an outcome of an event previously occurred for a record. For example, as shown in FIG. 5D, the Event column 325a may be populated by binary values indicating whether or not an outcome of an event corresponding to Event previously occurred for various records 315. In this example, the values indicate that the event previously occurred for record 0002, but did not previously occur for record 0001, 0003, or 0004.

In some embodiments, when populating the information describing the occurrences of terms or groups of terms corresponding to the merged features 130 for each record into one or more tables, the extraction module 110 also may transform a subset of the structured data 105a. For example, suppose that a column within a relational database table included among the structured data 105a corresponds to a country associated with each record, such that fields within this column are populated by values corresponding to a name of a country for a given record. In this example, if a value of a field for this column for record 0001 is “U.S.A.” and a value of a field for this column for record 0002 is “India,” the extraction module 110 may transform this information into binary values when populating fields in a table based on whether the value is found within a record (e.g., a value of 1 if the term is found within the record and a value of 0 if the term is not found within the record). Continuing with this example, the extraction module 110 may populate fields in the table corresponding to a “U.S.A.” column with a value of 1 for record 0001 and a value of 0 for record 0002. Similarly, in this example, the extraction module 110 may populate fields in the table corresponding to an “India” column with a value of 0 for record 0001 and a value of 1 for record 0002.

Referring once more to FIG. 4, once one or more tables have been populated with information describing the occurrences of the corresponding terms for each record, merging of features from the structured data 105a and the unstructured data 105b is complete. At this point, the machine learning module 120 may train the data model 150 based at least in part on a set of features selected from the merged features 130 (in step 208).

### Illustrative Embodiments

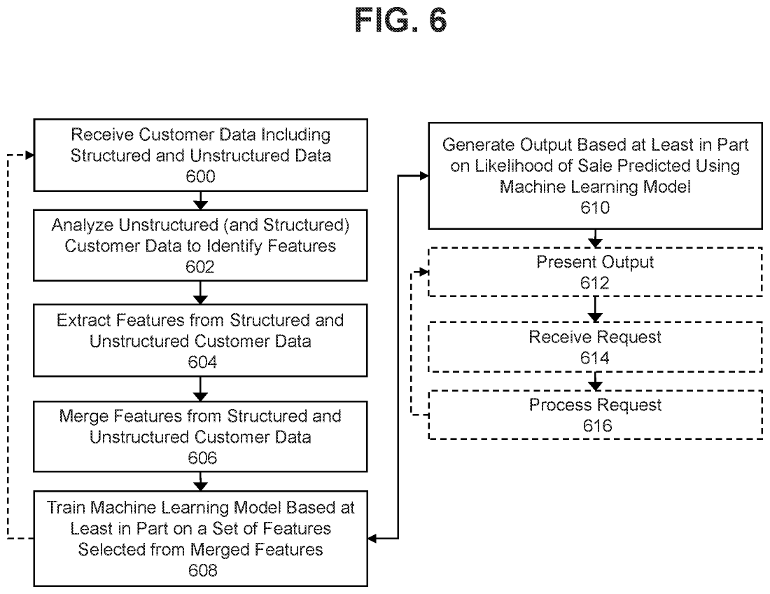

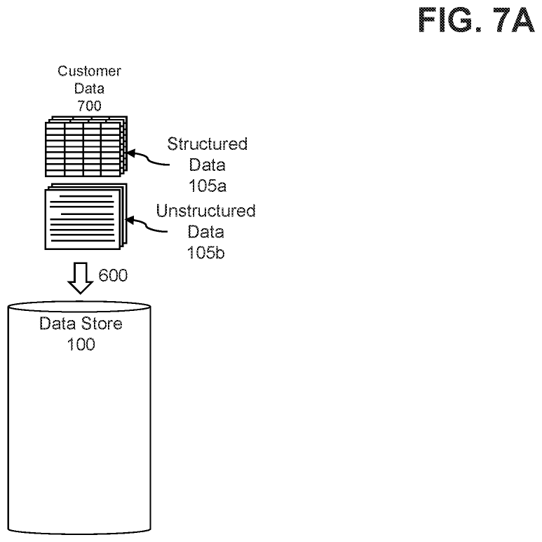

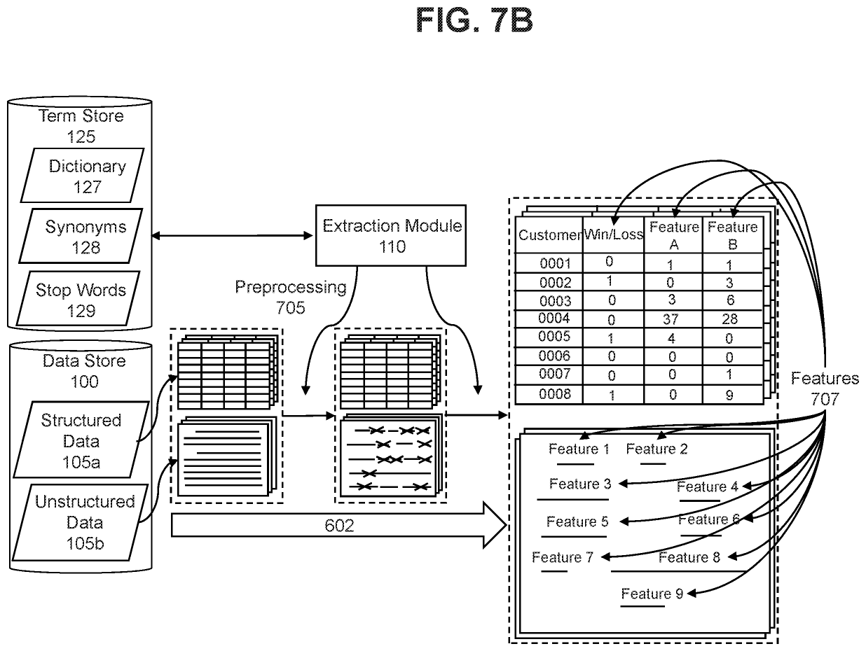

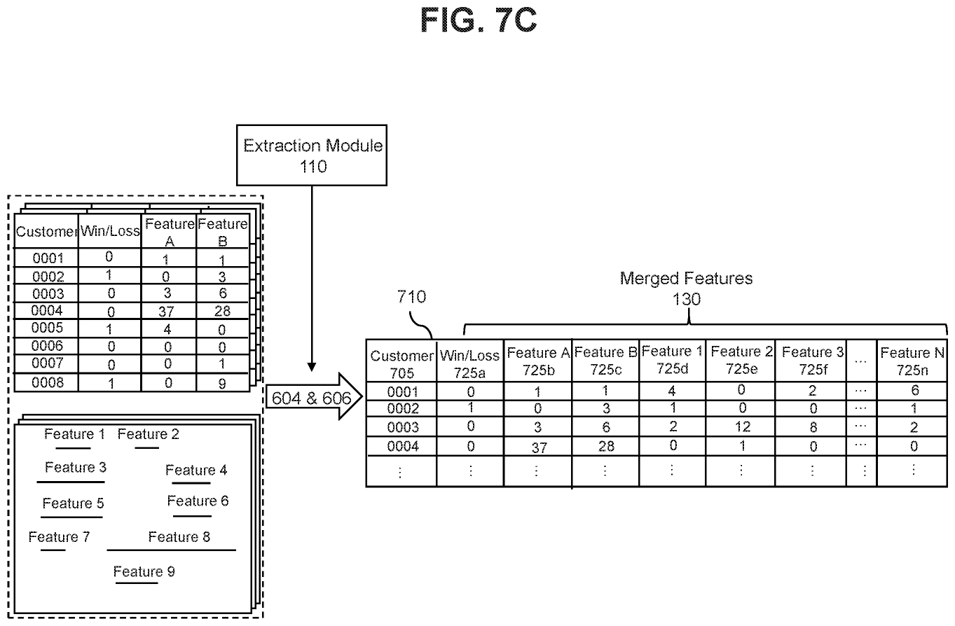

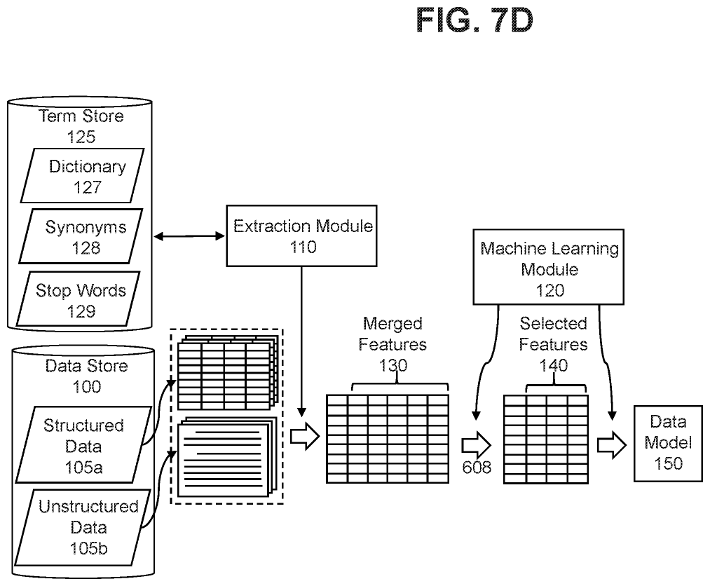

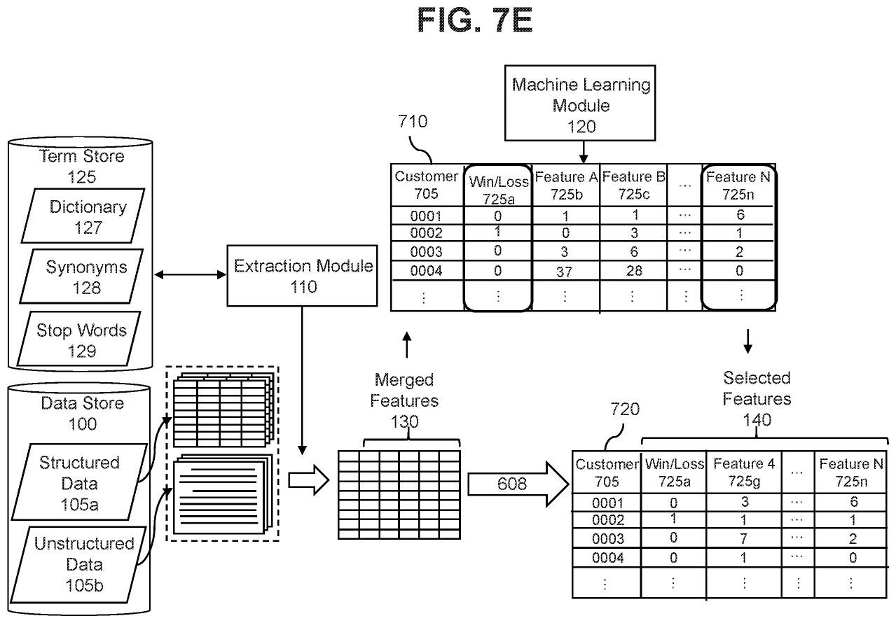

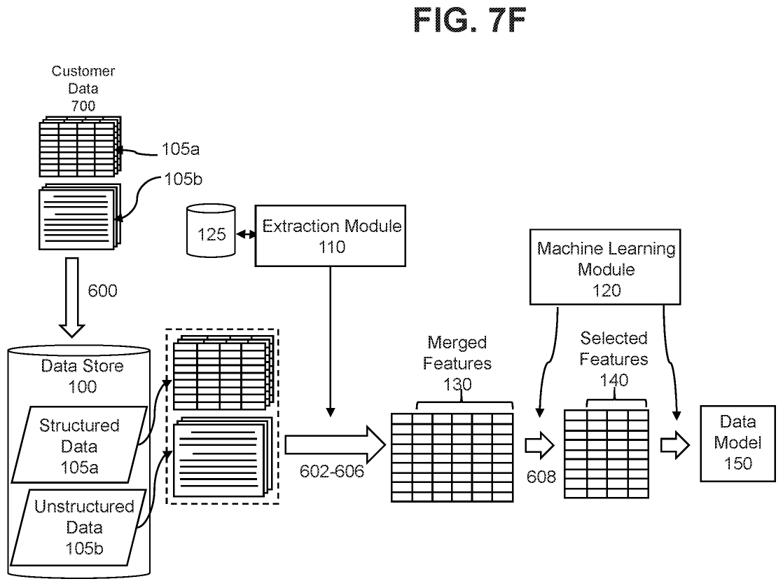

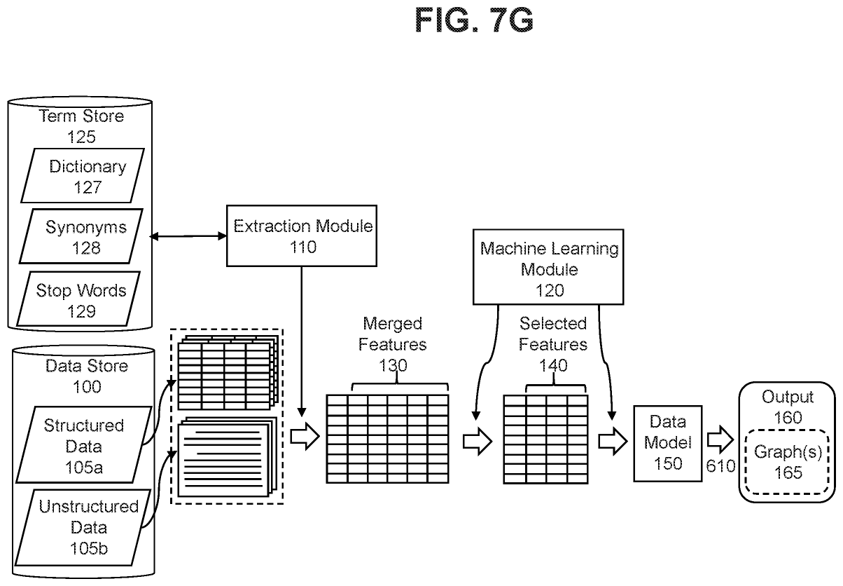

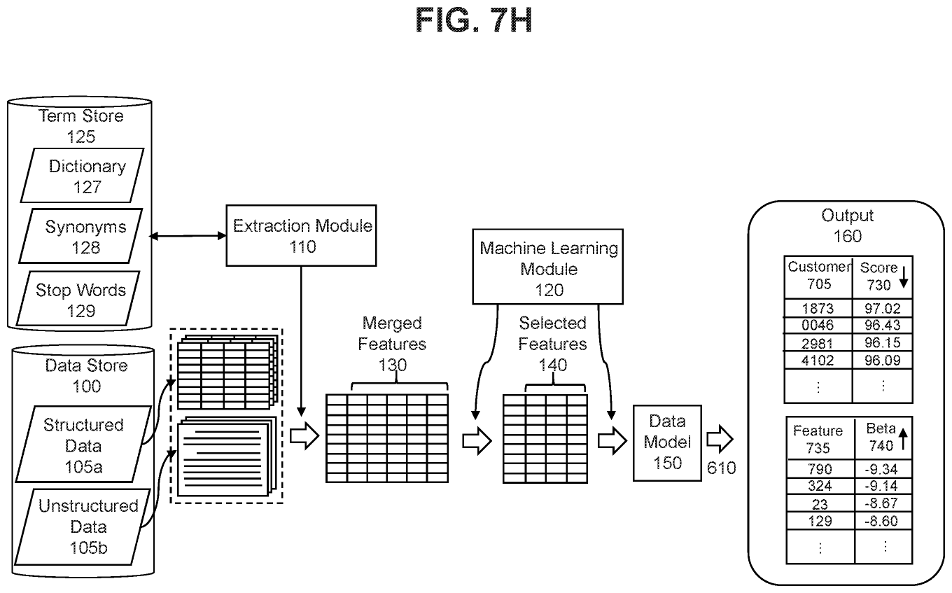

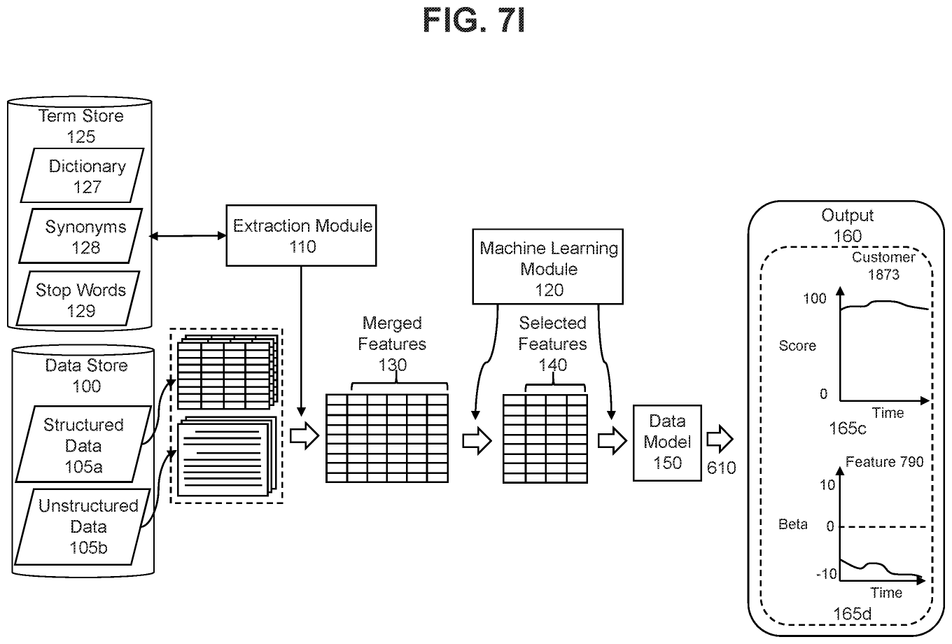

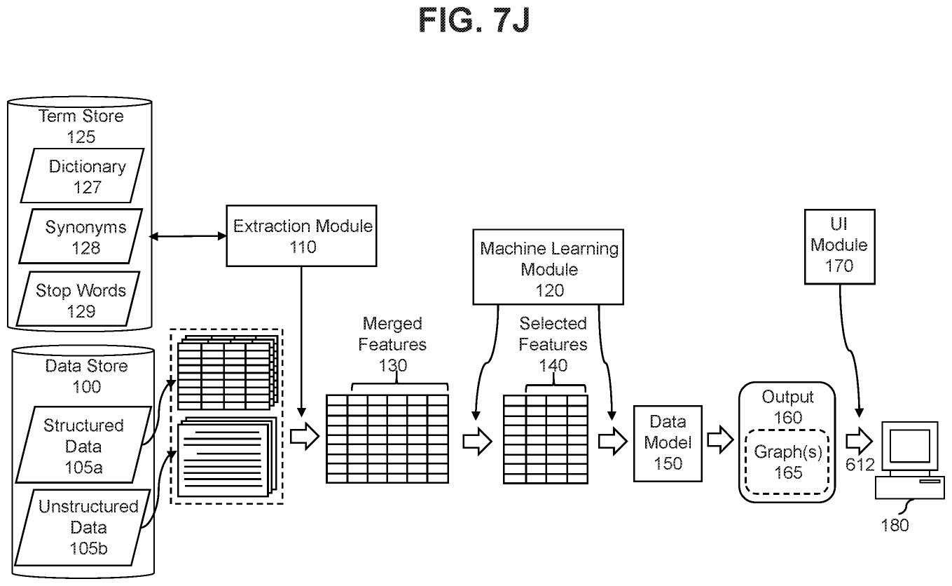

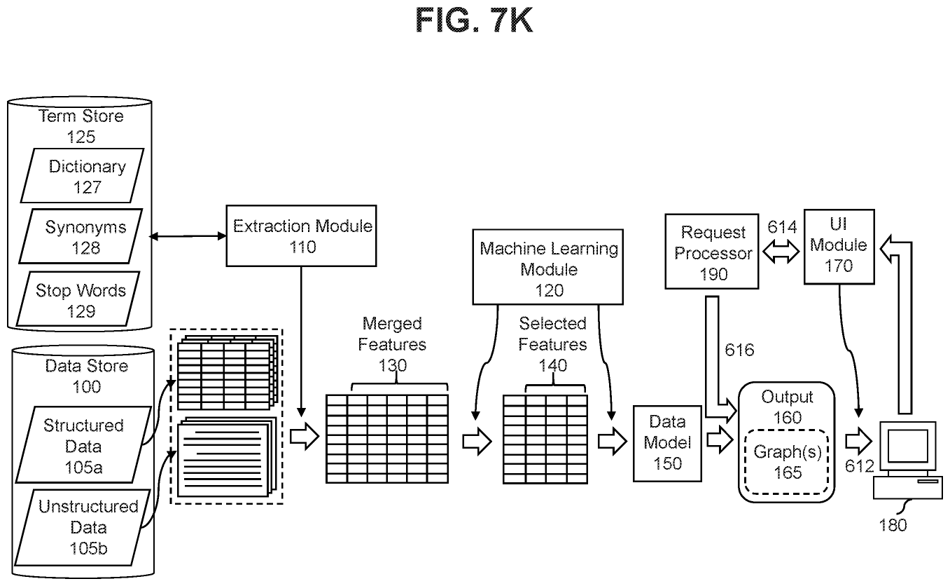

As illustrated in FIGS. 6 and 7A-7K, described below, in some embodiments, the approach described may be applied in the context of marketing and sales by predicting a likelihood of a sale of a product/service (e.g., to determine whether to pursue a sales opportunity, to determine how much of a product to produce, etc.). For example, suppose that records included among a set of data including structured data 105a and unstructured data 105b correspond to accounts for potential and existing customers of an entity that sells a particular product. In this example, the likelihood of the outcome of the event to be predicted by the data model 150 may correspond to the likelihood of a sale of the product. Continuing with this example, information included in the output 160 may be used by the entity to identify sales opportunities or “leads” that should be pursued (i.e., those that are most likely to result in a sale) and to identify sales opportunities that should be avoided (i.e., those that are not likely to result in a sale). Furthermore, in this example, as more sales data is accumulated, the data model 150 may be updated, increasing the confidence level of the predicted likelihoods over time. Moreover, the data model 150 may be used to generate an output 160 as soon as new data is available, such that any new data that might have a statistically significant effect on the sales process may be monitored and quickly identified by the output 160. Based on the output 160, the entity may allocate its resources to sales opportunities that are most likely to be profitable.

FIG. 6 illustrates a flowchart for predicting a likelihood of a sale using a machine learning model that is trained based at least in part on structured data and unstructured data according to some embodiments of the invention. In some embodiments, the steps may be performed in an order different from that described in FIG. 6.

As shown in FIG. 6, the flowchart begins when customer data including structured data 105a and unstructured data 105b is received (in step 600). In some embodiments, the customer data may include information associated with potential or existing customers of a business entity. Furthermore, in various embodiments, the customer data may be associated with multiple customers and a portion of the customer data for each customer may include structured data 105a and unstructured data 105b. For example, as shown in FIG. 7A, a set of customer data 700 including structured data 105a and a set of unstructured data 105b are received and stored in the data store 100. In this example, the structured data 105a may include one or more relational database tables, in which each row of a table corresponds to a record for a customer and each column of the table corresponds to an attribute of a customer (e.g., industry, geographic location, number of employees, etc.), such that fields within each column are populated by values of the attribute for the corresponding customers. Furthermore, the unstructured data 105b may include free-form text fields that include notes created by sales representatives indicating their impressions regarding each sales opportunity for a corresponding customer. In some embodiments, the unstructured data 105b may include multiple entries (e.g., free-form text fields created before and after successful and failed sales attempts) that have been merged together and which may be processed together by the extraction module 110 and the machine learning module 120, while in other embodiments, the unstructured data 105b may include multiple separate entries that have not been merged together and which may be processed separately. At least some of the structured data 105a and/or the unstructured data 105b also may include information describing previous successful sales attempts and previous failed sales attempts, the likelihood of which is to be predicted by the data model 150.

Referring back to FIG. 6, the unstructured data 105b included in the customer data is analyzed to identify various features included among the unstructured data 105b (in step 602). As indicated in step 602, in some embodiments, the structured data 105a may be analyzed as well to identify various features included among the structured data 105a. As described above, to identify the features, the extraction module 110 may perform various types of preprocessing procedures on the unstructured data 105b based at least in part on information stored in the term store 125. The preprocessing procedures may involve parsing the data, stemming/lemmatizing certain words, removing stop words, identifying synonyms, transforming the data, etc., and accessing the dictionary 127, the synonyms 128, and/or the stop words 129 stored in the term store 125. As described above, in some embodiments, at least some of the extracted features may correspond to terms (e.g., words or names) or other types of values (e.g., integers, decimals, characters, etc.) that are included among the unstructured data 105b and/or the structured data 105a. For example, as shown in FIG. 7B, which continues the example of FIG. 7A, once preprocessing 705 is complete, the terms remaining among the unstructured data 105b may be identified by the extraction module 110 as features 707 (Feature 1 through Feature 9). As also shown in this example, columns of the database tables (Win/Loss, Feature A, and Feature B) included among the structured data 105a also may be identified by the extraction module 110 as features 707. In some embodiments, analysis of the structured data 105a may be optional. For example, in FIG. 7B, analysis of the structured data 105a may not be required if each column within the tables of the structured data 105a corresponds to a feature by default.

As described above, in some embodiments, the extraction module 110 also may identify one or more records included among the structured data 105a and/or the unstructured data 105b, in which each record is relevant to a specific customer. In such embodiments, once the extraction module 110 has identified one or more records included among the structured data 105a and/or the unstructured data 105b, the extraction module 110 may then determine occurrences of the identified features within each record. For example, the extraction module 110 may determine a count indicating a number of times that a term corresponding to a feature appears within each record included among the structured data 105a and the unstructured data 105b. As an additional example, the extraction module 110 may determine whether a term corresponding to an identified feature appears within a record included among the structured data 105a and the unstructured data 105b.

Referring back to FIG. 6, next, the extraction module 110 may extract the identified features (in step 604) and merge them together (in step 606). In some embodiments, the features may be merged by populating them into one or more tables. For example, as shown in FIG. 7C, which continues the example discussed above with respect to FIGS. 7A-7B, features included among the structured data 105a identified by the extraction module 110 may be extracted and populated into columns (Win/Loss 725a, Feature A 725b, and Feature B 725c) of a table 710, such that each feature corresponds to a column 725 of the table 710 and fields within the columns 725 are populated by the corresponding values of the features for various customers 705 identified by customer numbers (0001, 0002, 0003, 0004, etc.). In this example, features included among the unstructured data 105b identified by the extraction module 110 may be extracted and populated into columns (Feature 1 725d, Feature 2 725e, Feature 3 725f, . . . ) of the same table 710 in an analogous manner, creating a single table of merged features 130. In embodiments in which the extraction module 110 determines occurrences of the identified features within each record for a customer, the values of the features for various customers may correspond to information describing these occurrences. For example, as shown in FIG. 7C, Feature 1 occurred four times within the record for customer 0001, once within the record for customer 0002, twice within the record for customer 0003, etc. As described above, at least one of the merged features 130 (e.g., Win/Loss) may correspond to previous successful sales attempts or previous failed sales attempts, the likelihood of which is to be predicted by the data model 150. In this example, values of the Win/Loss column 725a may be populated by a binary value indicating whether or not a sale occurred. In this example, the values indicate that a successful sales attempt previously occurred for Customer 0002, and that an unsuccessful sales attempt previously occurred for Customer 0001, Customer 0003, and Customer 0004.

Referring back to FIG. 6, a machine learning model is trained to predict the likelihood of the sale based at least in part on a set of features selected from the merged features 130 (in step 608). For example, as shown in FIG. 7D, which continues the example discussed above with respect to FIGS. 7A-7C, the machine learning module 120 may train the data model 150 based at least in part on a set of selected features 140. In this example, the training data used to train the data model 150 may include values corresponding to the selected features 140 for various records, which may be populated into one or more tables. In some embodiments, the set of features included among the selected features 140 is smaller than the set of features included among the merged features 130. In such embodiments, this may significantly reduce the amount of data that must be processed. For example, as shown in FIG. 7E, which continues the example discussed above with respect to FIGS. 7A-7D, the machine learning module 120 only selects some of the merged features 130 (Win/Loss 725a, Feature 4 725g, . . . Feature N 725n) and populates values corresponding to the selected features 140 for various customers 705 into a table 720. As described above, in various embodiments, when training the data model 150, the machine learning module 120 may identify a set of customers who are associated with previous successful sales attempts and previous failed sales attempts and a set of customers who are not associated with previous successful sales attempts and previous failed sales attempts (e.g., records associated with a null value for a corresponding feature), such that the records for the appropriate customers may be included in a training dataset and a test dataset.

The data model 150 may be trained by the machine learning module 120 using a regression algorithm (e.g., logistic regression or step-wise regression), a decision tree algorithm (e.g., random forest), or any other suitable machine learning algorithm. In some embodiments, the machine learning module 120 may train multiple data models 150 and select a data model 150 based at least in part on a process that prevents over-fitting of the data model 150 to data used to train the model (e.g. via regularization). For example, referring to FIG. 7E, suppose that there are 50,000 merged features 130, such that table 710 includes 50,000 columns that each correspond to a merged feature 130. In this example, suppose also that logistic regression is used to train the data model 150 and that the machine learning module 120 automatically excludes merged features 130 associated with beta values (regression coefficients) smaller than a threshold value from the selected features 140. Continuing with this example, a regularization process (e.g., L1, L2, or L1/L2 regularization) then imposes a penalty on each of the merged features 130 that potentially may be included among the selected features 140 used to train the data model 150 based on whether the feature improves or diminishes the ability of the data model 150 to predict the likelihood of the sale. In this example, if the most accurate data model 150 identified by the machine learning module 120 has selected 5,000 features from the 50,000 merged features 130, this data model 150 is output by the machine learning module 120.

Referring back to FIG. 6, in some embodiments the steps of the flow chart described above may be repeated each time new customer data (structured data 105a and/or unstructured data 105b) is received (in step 600). In such embodiments, steps 600 through 608 may be repeated, allowing the data model 150 to be updated dynamically by being retrained using new or different combinations of the merged features 130. For example, as shown in FIG. 7F, which continues the example discussed above with respect to FIGS. 7A-7E, new customer data 700 including structured data 105a and unstructured data 105b is received and stored among the structured data 105a and unstructured data 105b in the data store 100. Then, as also shown in FIG. 7F, the extraction module 110 identifies, extracts, and merges features from the structured data 105a and the unstructured data 105b (in steps 602-606) and the machine learning module 120 retrains the data model 150 based at least in part on a set of selected features 140 corresponding to a subset of the merged features 130 (in step 608). In some embodiments, efficiency may be improved by processing structured data 105a and/or unstructured data 105b only for records for which new data has been received.

Referring again to FIG. 6, once the data model 150 has been trained, it may generate an output 160 based at least in part on a likelihood of the sale predicted using the data model 150 (in step 610). The likelihood of the sale may be predicted based at least in part on a set of input values to the data model 150, in which the input values correspond to at least some of the selected features 140. For example, as shown in FIG. 7G, which continues the example discussed above with respect to FIGS. 7A-7F, the data model 150 may generate an output 160 that includes one or more predicted likelihoods of the sale. In this example, each of the likelihoods included in the output 160 may be predicted by the data model 150 for one or more customers whose records are included among the structured data 105a and/or the unstructured data 105b and who are not associated with previous successful sales attempts or previous failed sales attempts.

A predicted likelihood included in the output 160 may be expressed in various ways. In some embodiments, a predicted likelihood may be expressed numerically. For example, if the output 160 includes an 81 percent predicted likelihood of a sale for a particular customer, the predicted likelihood may be expressed as a percentage (i.e., 81%), as a decimal (i.e., 0.81), as a score (e.g., 81 in a range of scores between 0 and 100), etc. In alternative embodiments, a predicted likelihood may be expressed non-numerically. In the above example, the predicted likelihood may be expressed non-numerically based on comparisons of the predicted likelihood to one or more thresholds (e.g., “highly likely to occur” if the predicted likelihood is greater than 95%, “unlikely to occur” if the predicted likelihood is between 25% and 45%, etc.). Furthermore, in various embodiments, a predicted likelihood included in the output 160 may be associated with a confidence level. In such embodiments, the confidence level may be determined based at least in part on the amount of structured data 105a and/or unstructured data 105b used to train the data model 150.

The output 160 may be generated by the data model 150 based on multiple predicted likelihoods. In some embodiments, predicted likelihoods included in the output 160 may be expressed for a group of customers. For example, predicted likelihoods may be expressed for a group of customers having a common attribute (e.g., a geographic region associated with the customers) or a common value for a particular selected feature 140. Additionally, in various embodiments, the predicted likelihoods included in the output 160 may be sorted. For example, as shown in FIG. 7H, which continues the example discussed above with respect to FIGS. 7A-7G, the output 160 may include a table that lists each customer 705 and their corresponding predicted likelihood (expressed as a score 730 in this example). In this example, the table sorts the customers 705 by decreasing score 730. The output 160 therefore may reduce a large amount of structured data 105a and unstructured data 105b for each record into a single value corresponding to the predicted likelihood of the sale.

In various embodiments, in addition to the predicted likelihood(s) of the sale, the output 160 generated by the data model 150 also may include additional types of information. In some embodiments, the output 160 may indicate the relationship of one or more of the selected features 140 to the predicted likelihood of the sale. Furthermore, in embodiments in which the data model 150 is trained using a regression algorithm, the output 160 generated by the data model 150 may include beta values (estimates of the regression coefficients) associated with one or more of the selected features 140. For example, as shown in FIG. 7H, the output 160 may include a table that lists each feature 735 and its corresponding beta value 740. In this example, the table sorts the features 735 by increasing beta value 740. Although the features 735 included in the table are identified by a numerical identifier, in some embodiments, the identifier may be a term that corresponds to the feature 735 (e.g., a name of a competitor, a name of a competitor's product/service, a feature of a competitor's product/service, etc.). Furthermore, as shown in FIG. 7I, which continues the example discussed above with respect to FIGS. 7A-7H, in some embodiments, the output 160 may include one or more graphs 165. The graphs 165 may plot information included in the output 160 that has been tracked over a period of time. As shown in FIG. 7I, the output 160 may include a graph 165c that plots the likelihood of the sale (expressed as a score) predicted for a particular customer (Customer 1873) over a period of time. As shown in FIG. 7I, the output 160 also may include a graph 165d that plots a value (beta value) that quantifies a relationship of a particular selected feature 140 (Feature 790) used to train the data model 150 to the likelihood of the outcome of the sale predicted over a period of time.

Referring back to FIG. 6, in some embodiments, once generated, the output 160 of the data model 150 may then be presented (in step 612). In some embodiments, the output 160 may be presented to a user (e.g., a system administrator) at a management console 180. For example, as shown in FIG. 7J, which continues the example discussed above with respect to FIGS. 7A-7I, the output 160 may be presented at a management console 180 via a UI generated by the UI module 170.

Referring once more to FIG. 6, once the output 160 has been presented, a request may be received (in step 614) and processed (in step 616). Furthermore, once the request has been processed, in some embodiments, some of the steps of the flow chart described above may be repeated each time a new request is received (in step 614). In such embodiments, steps 612 through 616 may be repeated. For example, as shown in FIG. 7K, which continues the example discussed above with respect to FIGS. 7A-7J, if a request is received from the management console 180 via a UI generated by the UI module 170, the request may be forwarded to and processed by the request processor 190. The request processor 190 may then generate an output 160 which may then be presented. As described above, the request processor 190 may access any portion of the system (e.g., the data store 100, the data model 150, etc.) to process a request. For example, suppose that a request received at the management console 180 corresponds to a request for information describing the selected features 140 that contributed the most to a difference between the likelihood of the sale predicted for a particular customer at two different times. In this example, based on the customer and times identified in the request, the request processor 190 may access the data model 150 and values of the selected features 140 for the identified customer, determine a contribution of each of the selected features 140 to the difference for the identified customer, and sort the selected features 140 based on their contribution. Continuing with this example, the request processor 190 may generate an output 160 that includes a sorted list of the selected features 140 and graphs 165 describing trends of beta values for each of the selected features 140 that is presented at the management console 180 via a GUI generated by the UI module 170. In the above example, a subsequent request received from the management console 180 may correspond to a request for information identifying features that have a trend of beta values similar to those shown in one or more of the graphs 165. In this example, the subsequent request may be processed by the request processor 190, which may then generate an output 160 that is then presented.

As described above, in some embodiments, the request processor 190 may receive a set of inputs for the data model 150 and communicate them to the data model 150, which may generate the output 160 based at least in part on the inputs. For example, as shown in FIG. 7K, if a request to run the data model 150 using a particular set of inputs is received at the management console 180 and forwarded to the request processor 190, the inputs may be forwarded to the data model 150, which generates an output 160 that may then be presented at the management console 180 via a UI generated by the UI module 170.

Therefore, based on the output(s) 160 generated by the data model 150 and/or the request processor 190 an entity may more efficiently allocate resources involved in a sales process. In some embodiments, the approach described above also may be applied to other contexts. For example, the approach may be applied to medical contexts (e.g., to determine a likelihood of a diagnosis), scientific contexts (e.g., to determine a likelihood of an earthquake), or any other suitable context to which machine learning may be applied to predict the likelihoods of various events. In such embodiments, depending on the context, the predicted likelihood of the outcome of the event may be compared to different thresholds to determine how resources should be allocated.

### System Architecture

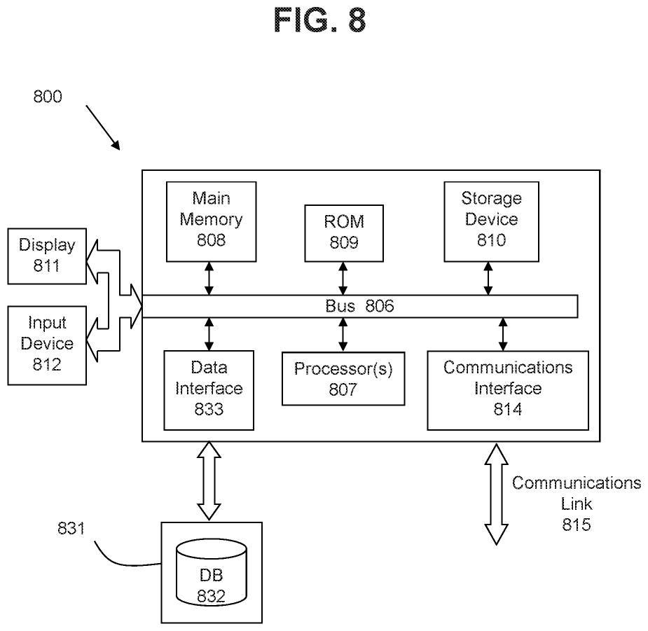

FIG. 8 is a block diagram of an illustrative computing system 800 suitable for implementing an embodiment of the present invention. Computer system 800 includes a bus 806 or other communication mechanism for communicating information, which interconnects subsystems and devices, such as processor 807, system memory 808 (e.g., RAM), static storage device 809 (e.g., ROM), disk drive 810 (e.g., magnetic or optical), communication interface 814 (e.g., modem or Ethernet card), display 811 (e.g., CRT or LCD), input device 812 (e.g., keyboard), and cursor control.

According to some embodiments of the invention, computer system 800 performs specific operations by processor 807 executing one or more sequences of one or more instructions contained in system memory 808. Such instructions may be read into system memory 808 from another computer readable/usable medium, such as static storage device 809 or disk drive 810. In alternative embodiments, hard-wired circuitry may be used in place of or in combination with software instructions to implement the invention. Thus, embodiments of the invention are not limited to any specific combination of hardware circuitry and/or software. In some embodiments, the term “logic” shall mean any combination of software or hardware that is used to implement all or part of the invention.

The term “computer readable medium” or “computer usable medium” as used herein refers to any medium that participates in providing instructions to processor 807 for execution. Such a medium may take many forms, including but not limited to, non-volatile media and volatile media. Non-volatile media includes, for example, optical or magnetic disks, such as disk drive 810. Volatile media includes dynamic memory, such as system memory 808.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 800. According to other embodiments of the invention, two or more computer systems 800 coupled by communication link 810 (e.g., LAN, PTSN, or wireless network) may perform the sequence of instructions required to practice the invention in coordination with one another.

Computer system 800 may transmit and receive messages, data, and instructions, including program, i.e., application code, through communication link 815 and communication interface 814. Received program code may be executed by processor 807 as it is received, and/or stored in disk drive 810, or other non-volatile storage for later execution. A database 832 in a storage medium 831 may be used to store data accessible by the system 800.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A method comprising:
identifying a first feature from unstructured data based at least in part on an analysis of the unstructured data, the first feature corresponding to a term within the unstructured data;
extracting the first feature from the unstructured data and a second feature from structured data;
creating a merged set of features by merging the first feature extracted from the unstructured data with the second feature extracted from the structured data;
training a machine learning model to predict a likelihood of an outcome of an event based at least in part the merged set of features.

2. The method of claim 1, further comprising generating an output based at least in part on the likelihood of the outcome of the event, the likelihood of the outcome of the event predicted based at least in part on the merged set of features.

3. The method of claim 2, wherein generating the output based at least in part on the likelihood of the outcome of the event comprises: (a) plotting a value that quantifies a relationship of the merged set of features to the likelihood of the outcome of the event predicted over a period of time or (b) plotting the likelihood of the outcome of the event predicted over the period of time.

4. The method of claim 1, wherein the unstructured data comprises free-form text data that has been merged from a plurality of free-form text fields.

5. The method of claim 1, wherein the term comprise a synonym.

6. The method of claim 1, wherein creating the merged set of features by merging the first feature extracted from the unstructured data with the second feature extracted from the structured data comprises:
associating a column of a table with a respective one of the first feature and the second feature; and
populating a field of the column of the table with information describing an occurrence of the term corresponding to a feature associated with the column for a record.

7. The method of claim 1, wherein the merged set of features corresponds to a third feature associated with a value that quantifies a relationship of the third feature to the outcome of the event.

8. A computer program product embodied on a non-transitory computer readable medium, the computer readable medium having stored thereon a sequence of instructions which, when executed by a processor causes the processor to execute a method comprising:
identifying a first feature from unstructured data based at least in part on an analysis of the unstructured data, the first feature corresponding to a term within the unstructured data;
extracting the first feature from the unstructured data and a second feature from structured data;
creating a merged set of features by merging the first feature extracted from the unstructured data with the second feature extracted from the structured data;
training a machine learning model to predict a likelihood of an outcome of an event based at least in part on the merged set of features.

9. The computer program product of claim 8, wherein the computer readable medium further comprises an instruction for generating an output based at least in part on the likelihood of the outcome of the event, the likelihood of the outcome of the event predicted based at least in part on the merged set of features.

10. The computer program product of claim 9, wherein generating the output based at least in part on the likelihood of the outcome of the event comprises: (a) plotting a value that quantifies a relationship of the merged set of features to the likelihood of the outcome of the event predicted over a period of time or (b) plotting the likelihood of the outcome of the event predicted over the period of time.

11. The computer program product of claim 8, wherein the unstructured data comprises free-form text data that has been merged from a plurality of free-form text fields.

12. The computer program product of claim 8, wherein the term comprise a synonym.

13. The computer program product of claim 8, wherein creating the merged set of features by merging the first feature extracted from the unstructured data with the second feature extracted from the structured data comprises:
associating a column of a table with a respective one of the first feature and the second feature; and
populating a field of the column of the table with information describing an occurrence of the term corresponding to a feature associated with the column for a record.

14. The computer program product of claim 8, wherein the merged set of features corresponds to a third feature associated with a value that quantifies a relationship of the third feature to the outcome of the event.

15. A computer system comprising:
a processor;
a memory for holding programmable code; and
wherein the programmable code includes instructions for:
identifying a first feature from unstructured data based at least in part on an analysis of the unstructured data, the first feature corresponding to a term within the unstructured data;
extracting the first feature from the unstructured data and a second feature from structured data;
creating a merged set of features by merging the first feature extracted from the unstructured data with the second feature extracted from the structured data;
training a machine learning model to predict a likelihood of an outcome of an event based at least in part on the merged set of features.

16. The computer system of claim 15, wherein the programmable code further comprises an instruction for generating an output based at least in part on the likelihood of the outcome of the event, the likelihood of the outcome of the event predicted based at least in part on the merged set of features.

17. The computer system of claim 16, wherein generating the output based at least in part on the likelihood of the outcome of the event comprises: (a) plotting a value that quantifies a relationship of the merged set of features to the likelihood of the outcome of the event predicted over a period of time or (b) plotting the likelihood of the outcome of the event predicted over the period of time.

18. The computer system of claim 15, wherein the unstructured data comprises free-form text data that has been merged from a plurality of free-form text fields.

19. The computer system of claim 15, wherein the term comprise a synonym.

20. The computer system of claim 15, wherein creating the merged set of features by merging the first feature extracted from the unstructured data with the second feature extracted from the structured data comprises:
associating a column of a table with a respective one of the first feature and the second feature; and
populating a field of the column of the table with information describing an occurrence of the term corresponding to a feature associated with the column for a record.

21. The computer system of claim 15, wherein the merged set of features corresponds to a third feature associated with a value that quantifies a relationship of the third feature to the outcome of the event.
